(19) United States
(12) Patent Application Publication
(10) Pub. No.: US 2015/0095249 A1
(43) Pub. Date: Apr. 2, 2015

(54) Website Platform to Locate and Engage with International Diasporas

(71) Applicant: Roland Ahouelete Yaovi HOLOU, St Louis, MO (US)

(72) Inventor: Roland Ahouelete Yaovi HOLOU, St Louis, MO (US)

(21) Appl. No.: 14/181,610

(22) Filed: Feb. 14, 2014

Related U.S. Application Data
(60) Provisional application No. 61/883,332, filed on Sep. 27, 2013.

(51) Int. Cl. G06Q 50/00; H04L 12/58

(52) U.S. Cl. CPC G06Q 50/01; H04L 51/32
USPC 705/319

(57) ABSTRACT

A website platform focused around sharing needs or offers amongst people of similar residence and/or origin allows users to locate and engage diasporas across the world. This global platform provides each user to interact amongst each other through a plurality of communication, and development resources. Some of these resources are: the ability of send and receive messages; the ability to view, organize, and manage a user's contacts list, and the ability to create and join networking groups. One of the most important resources is the ability to create and add needs/offer posts to a common board that can be seen by all users. This allows users to view opportunities on need/offer posts that could connect diaspora users of any residence or origin. This international diaspora platform provides a unique environment that addresses some of the crucial problems associated with human migration or movement across the globe.

The current application claims a priority to the U.S. Provisional Patent application Ser. No. 61/883,332 filed on Sep. 27, 2013.

### FIELD OF THE INVENTION

The present invention relates generally to a website platform for connecting and engaging the global diaspora with others (including but not limited to individuals, organizations, schools, research centers, companies, governments, and international institutions), acting as a centralized resource for locating, networking, developing, and interacting with the national and international communities.

### BACKGROUND OF THE INVENTION

Human beings have a growing tendency to migrate from their native region or country to another to adjust to life's challenges and solicitations, or to explore better opportunities. In some extreme cases, those movements are involuntary. With the increasing rise of problems and crises around the globe (e.g. economy, demography, politics, war, unemployment, climate change, and technology), human's migration will keep growing. People move not only from developing countries to developed countries, but also from a developed country to another. The situation has been worsening in developing countries in a way that the brain drain is seen as one of the greatest threats against their development. Moreover, some developed countries are elaborating, advocating, and promoting policies and immigration laws that will encourage foreign talented graduate students to come into those countries or to maintain them in the host countries after their graduation, a way to try to solve the manpower problem of those host countries. Unfortunately, while these strategies profit the host countries, they worsen the problem of human resources in the countries of origin of those graduate students or pundits. So far, the efforts to stop brain drain have been unsuccessful in most affected countries. Additionally, it is impossible to prevent the developed countries from encouraging brain drain to satisfy their human resource needs. Simultaneously, it is impossible to force people to stay in their home countries because doing so may violate their freedom of decision and restrict their creativity and productivity as a human resource. Indeed, human beings desire to travel, explore new places, and try to understand things; and that tendency to expand their knowledge causes human beings to innovate, and think beyond the immediate needs and limitations that life can put on them. Other talented people who choose to stay in their home countries don't usually have the technology and resources required to succeed and compete in a global economy. While some immigrants succeed, others do not. The professional and personal lives of those who failed are sometimes worse than those in their native country. Some people envisioned better life abroad, however, when they get there, they are disappointed their dream didn't happen the way they thought and, they return home only to realize their dream, after all, could be fulfilled in their homeland. Few people need to move to other countries, succeed and then stay there.

Usually, because of a lack of information or right connections or knowledge, several immigrants do not produce the best of themselves. At the same time, those who succeed do not often collaborate or network with the newly arriving immigrants or those who are not succeeding. Some new aliens would like to find some close and successful immigrants to mentor them, but they don't know where to find them. In spite of the problems they usually encounter in foreign lands, countless people living in diaspora are solicited by their relatives or friends from their home countries more than they can handle. Besides money they often send back to their relatives, the diasporas of most countries, often times, neglect to contribute to the development of their country of birth.

Other diasporas' members who are willing to help or give back to their country of origin or to other places they previously lived, don't know how, where, and who to contact to reach the real needy or to solve the real problems. At the same time, the diasporas are unknown by many service providers in their host countries, therefore reducing the likelihood of solving their problems using the tools that their host countries provide. This lack of information and connection causes a huge loss of profit to many businesses and nonprofits because they are not reaching most of their market.

Furthermore, many diaspora's members complicate the situation by embracing their cultural habits or by having difficulty adapting to the culture or requirements of their host countries. In summary, the diasporas are not reaching their potential yet because to some extent, they lack connections and knowledge in their host countries while at the same time they are disconnected from their home countries.

It seems like human beings better interact with people with whom they share some common background; and when that background is the country of origin, the interaction is even easier. Similarly, some people delight in helping those who have been helpful to them in the past.

Regardless of their location, the diasporas, their countries of origin, and their host countries, would ideally work together to develop their people in a win-win manner. Across the globe, the diasporas constitute numerous business opportunities for all countries, and a significant potential to develop nations; but unfortunately, no comprehensive global and strategic platform has unselfishly tapped into that potential yet. Therefore, building a global win-win business or partnership between the diasporas, their home countries, and their host countries is a novel ideal and is a sustainable way to better develop the people and their nations while making some money to help others, which are the objectives of the present invention.

### HISTORY OF THE INVENTION

The business was founded by Dr. Roland Holou (a dual citizen of the U.S.A. and Benin Republic). Roland grew up in Benin (West Africa) in a family of more than 30 brothers and sisters. Quickly, Roland knew that, to succeed in life, he has to work very hard and count on God who is able to provide the daily bread to the poor, the needy, and the afflicted. Since he was a teenager, Roland was continually exploring ways to succeed in school to better his life in the future. Because of that early determination, Roland has been very brilliant in school. However, the more educated he received, the more he realized that the education system in his home country was not adequate to the need of the country. By the time he graduated from high school, he began writing his first book to address some of the educational problems in his home country. Before completing his bachelor degree in 2001, he had finished writing that book, but due to some limitations, he had to wait for 6 years before being able to publish it. In addition to what he believes is a destiny, his desire to get a greater education and a better life compelled him to move to the US in 2003, a few months after finishing his Bachelor Degree in Agronomy and Master of Science Degree in Agricultural Engineering at the University of Abomey Calavi in Benin.

Unfortunately, Roland did not succeed in his first year in Washington D.C. He became disappointed with what he saw in the U.S. (the land of opportunities) and how people were suffering in that land which many considered the greatest nation on earth. He then returned to Africa. After spending about a year there, he was convinced to go back to the US. Upon his return to the U.S. in 2004, he worked very hard and went to school to get his Ph.D. During all those times, he witnessed the challenges of many Diaspora members, and he kept thinking about strategies to succeed and to help others. While he was struggling to achieve his dream in the U.S., relatives and friends in Africa were unceasingly asking him for help more than he was capable. Those to whom he tried to explain his conditions did not believe him. In the midst of those circumstances, he capitalized his experiences and lessons into a book he published in 2007 in Canada under the title Pourquoi l'Afrique Pleure et S'enfonce, which addressed some of the main causes and solutions to Africa's misery. The feedback he received from that book and his new thoughts made him conclude that the poverty in Africa has to do with the failure of the African leaders and pundits.

In 2008, he published the details about that new thought in a book at the premier French publisher in Europe. At that time, he was linking the poverty in Africa mainly to the lack of education of the Africans that remain in Africa, the political environment, the cultural realities, the brain drain, and the influence of foreign countries who will always try to defend their interests in Africa. Roland quickly realized that the English-speaking people need to hear about his books which so far were written in French, the official language of his native country. Therefore, while he was finishing his Ph.D. in Plant, Insect and Microbial Sciences at the University of Missouri in Columbia (USA), where he graduated as the Doctoral Marshal, Roland managed to translate his second book into English and published it in the U.S. in 2010 under the title of A Continent in Tears: The origin of Africa's collapse and how to reverse it.

Meanwhile, he kept working on the development of Africa, and found that in order for Africa to fully develop, it must capitalize on the potential of its diasporas by treating them not just as people who must help Africa, but also as people who need help from Africa as well as their host countries. Since then, Roland kept thinking over and over about how to bring the African countries together with their diasporas in a way that can be beneficial for all. As he continued to capitalize on what he had experienced in the U.S. and with his own people, and what he had learned from other Africans living in the diasporas and in Africa, Roland concluded that a platform must be created to bring the diasporas and its people together around problems and solutions that concern both. He then began writing the project to develop Africa based on its diasporas and vice versa. By that time, he also experienced and witnessed some serious challenges and difficulties in the workplace.

During his review of the literature, Roland decided to learn more about the diasporas of the other continents. Amazingly, he discovered that, in spite of the development levels, all continents (including Asia, America, Europe, and Australia) are encountering the same problems that Africa has had to cooperatively work with their diasporas to develop themselves, particularly in the context of brain drain and the international laws and strategies that encourage it.

In general, according to Roland Holou's diagnostics, here are the dilemmas that most diasporas, their home countries, and their country of residence find themselves in:
For many reasons, most people leave their country of origin to go into adventure hoping for a better life that, unfortunately, they don't usually find as originally planned.
For most people living in the diaspora, getting better opportunities to solve their problems and achieve their adventure dream is their main priority.
People and organizations in the country of origin of the diasporas (particularly developing countries e.g. Africa, Asia, Central America, and South America) address most of their needs for assistance to their relatives in the diaspora, thinking that those relatives are really having a better life abroad.
Some people in the country of origin of the diasporas are interested in receiving free gift back from the diasporas regardless of their success or not.
At the same time, nothing is that free for the diasporas in the foreign countries they find themselves in. Most of the free things the diasporas get abroad are not enough to really help them find a sustainable way of success. Therefore, to really succeed abroad, most diasporas have to pay a high price.
Usually, at their turn, most people living in the diaspora (at least the newcomers/migrants and those who are struggling to succeed) tend to ask the people in their host country to help them.
Not only do native individuals, organizations, and businesses in the diaspora country of residence are overloaded with requests for free help, but also, they would prefer the diaspora members (who are living by them) to buy their professional services and products rather than just ask for free help.
Usually, most diasporas are not well understood for instance because of the language and cultural barriers, but also because of a lack of integration into their new environment where sometimes, the autochthonous are barely making it.
As the diasporas have their problems that they cannot solve, so the people and organizations in the diasporas' host country have their own that they cannot or they do not want to solve free of charge those of the diaspora.
Meanwhile, certain organizations and governmental institutions strategically take advantage of this situation that many people and nations do not and/or can't fully understand.
Because of the problems mentioned above, it generally takes too long for most diaspora members to achieve their goals and succeed.
The diaspora members, who we think succeed, do not usually reach their full potential, and if they do, it takes too long to get there.
By the time they succeed, most diaspora's members incurred a lot of debt, frustrations, and other problems that cause them to focus on themselves rather than really thinking about helping those in their country of origin as the latter wish.
Some of those who succeed and who want to give back do not know where the real needs are and how they can engage themselves and others.
   According to Roland Holou's diagnostic, to sustainably solve the problems of each of the parties mentioned above, a system must be built where the diaspora, the people and organizations in their country of origin and in their host countries, can work together to help each other in a win-win framework. Unfortunately, that is the equation many countries failed to solve, and many migratory problems including brain drain has never been sustainably solved. Therefore, Roland understood that instead of developing a platform that will only work for Africa, he would rather work on a global platform that will address the main needs of all nations and their international diasporas in a win-win framework. Consequently, he extensively studied the diasporas of all continents and then created the present invention, which is the premier and world's largest website platform to locate, engage, and network with the global diasporas and with the people and organizations in their home country and/or in their country of residence. This is the challenge that Dr. Roland Holou has spent his life trying to solve, and that is how the present invention has been created and launched at a time that Dr. Roland Holou was unemployed for more than 16 months in the greatest and most developed nation on earth.

### SUMMARY OF THE INVENTION

Millions of people are leaving their home country to go to others countries each year. Even within a country, many people are moving all the time, seeking better opportunities, or trying to adjust to life's challenges and solicitations. The situation has been worsening in developing countries in a way that the brain drain is seen as one of the greatest threats against their development. So far, the efforts to stop or properly manage brain drain have been unsuccessful.

Unfortunately, many people are usually disappointed by what they see after moving, and others are disconnected from people and opportunities in their home country as well as in their host country. Those who succeed often do not collaborate/network with the newly arriving immigrants or with those who are not reaching their dreams. This global problem impoverishes nations and deprives many organizations from reaching most of their potential market, clients, and customers. To sustainably solve this problem, a global system must be built where the diaspora, the people and organizations in their country of origin and in their host country can work together to mutually help each other, which is an objective of the present invention.

Usually, the term “diaspora” refers to people who are living in a country or town that is not their place of origin/ancestry or the place they call home; but the term “diaspora” as used here applies to any human being.

The present invention is the world's premier and largest diaspora engagement network platform, connecting the international diasporas, organizations, and institutions to each other and to opportunities with governments, nonprofits, businesses, laboratories, schools, and research institutes locally and worldwide. The present invention thus allows those parties to be more productive and successful by better working and networking with those in their home country and in their country of residence.

As the world's first global diaspora comprehensive website platform, the present invention links the international diaspora groups to people and organizations in their home country as well as in their country of residence to detect, harvest, and transfer resources, services, and opportunities between people, organizations, and nations in a win-win framework. For instance, on that platform, governmental agencies can find tips and opportunities to successfully locate and engage with their diasporas. Immigrants and travelers can find free assistance to address their moving, traveling, and migration needs. Nonprofits as well as professional and nonprofessional associations/networks employ the service to voice and satisfy their local and international requests. On that site, registered users get free tools to engage with local and global philanthropic donations, including directly giving and/or receiving goods/services to or from anyone locally or worldwide. Businesses can find local and international opportunities to grow and improve their profit. Consultants can also obtain free resources to satisfy their consulting needs. Salespersons can find sales opportunities and attract more clients/customers. Buyers can locate and purchase good deals. The present invention helps research institutes needing anything related to science, collaboration, grants, funding, publishing, and the scientific communities. Laboratories also uncover opportunities to get funded, hire great scientists, and find great partners, investors, and technology to advance their investigations. The present invention assists students, faculty, teachers, schools, educational institutions, nations, and organizations to get to the bottom of their educational problems. Recruiters and recruiting agencies also find the present invention suitable for finding outstanding career development/placement opportunities locally or worldwide. Unemployed people receive free tips to get a job, start a new business, or solve their unemployment problems. Volunteers interested in local and international volunteering opportunities will also find the platform very helpful. Retired people can use this international networking site to discover tools and resources required to have a great retirement anywhere without messing up their savings.

All it takes to start benefiting from the present invention is to register an account, have a profile about your competency, needs, and services you would like to provide or receive from others. Then, log into your account to post needs and offers so that others can view and respond to them. On the registered users' dashboard, they can message others, look for new connections, find matches, create and or join new groups, chat with other users, and whole lot more to be detailed below.

The present invention also covers all applications that can be based on this platform such as website, applets, apps devices, mobile device, software application, software programs, system software, system program, hardware, operating system, handheld device, handheld computer, widgets, plugins, other medias, etc. The present invention can be written in, but not limited to, the following computer languages: php, ajax, css, html, javascript, and other programming tools.

### BRIEF DESCRIPTION OF THE DRAWINGS

FIG. 1 is an illustration of a main page interface of the present invention.

FIG. 2 is an illustration of a dashboard interface of the present invention.

FIG. 3 is an illustration of a message interface of the present invention.

FIG. 4 is an illustration of a search function of the present invention.

FIG. 5 is an illustration of a contacts interface of the present invention.

FIG. 6 is an illustration of a posting interface of the present invention, wherein a user is prompted to select from a plurality of fields.

FIG. 7 is an illustration of the posting interface of the present invention, wherein the user has selected the “buyer” field.

FIG. 8 is an illustration of an interface showing matching needs/offers of the present invention.

FIG. 9 is an illustration of a compact profile interface of the present invention.

FIG. 10 is an illustration of an interface showing recently posted needs/offers of the present invention.

FIG. 11 is an illustration of an interface for providing more information about a posted need/offer of the present invention.

FIG. 12A is an illustration of a plurality of fields for an account interface of the present invention.

FIG. 12B is an illustration of a photo upload interface of the present invention.

FIG. 13 is an illustration of the “who viewed the user, who the user viewed, and who joined” summary seen from the dashboard interface.

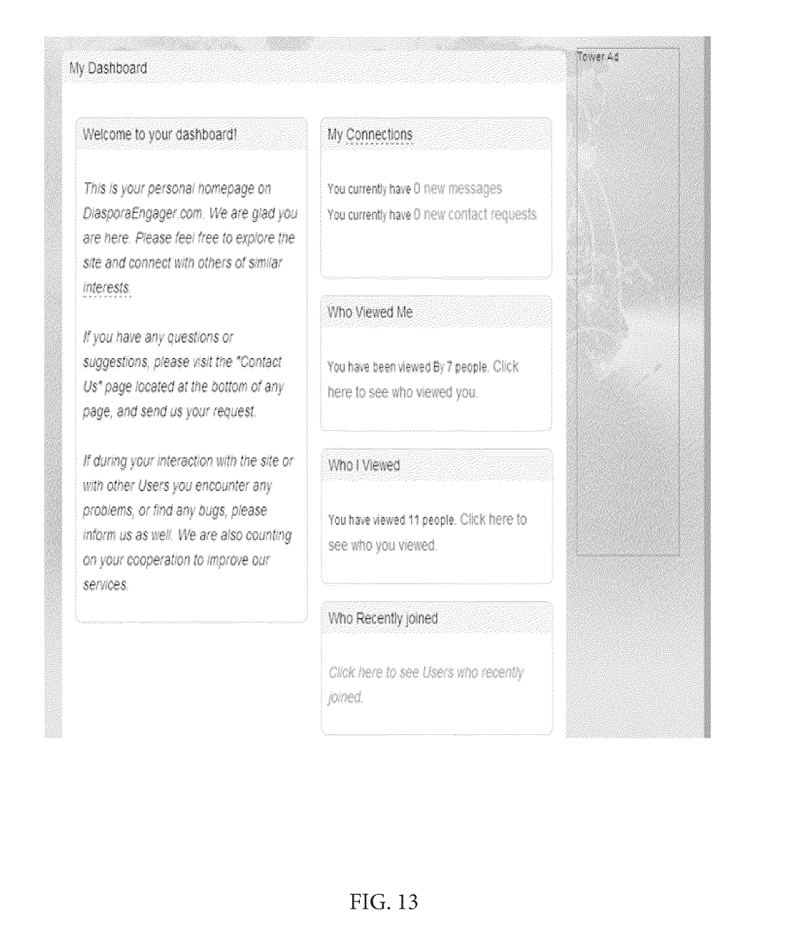

FIG. 14 is an illustration of a detailed “who viewed the user” page for the present invention.

FIG. 15 is an illustration of a detailed “who the user views” page for the present invention.

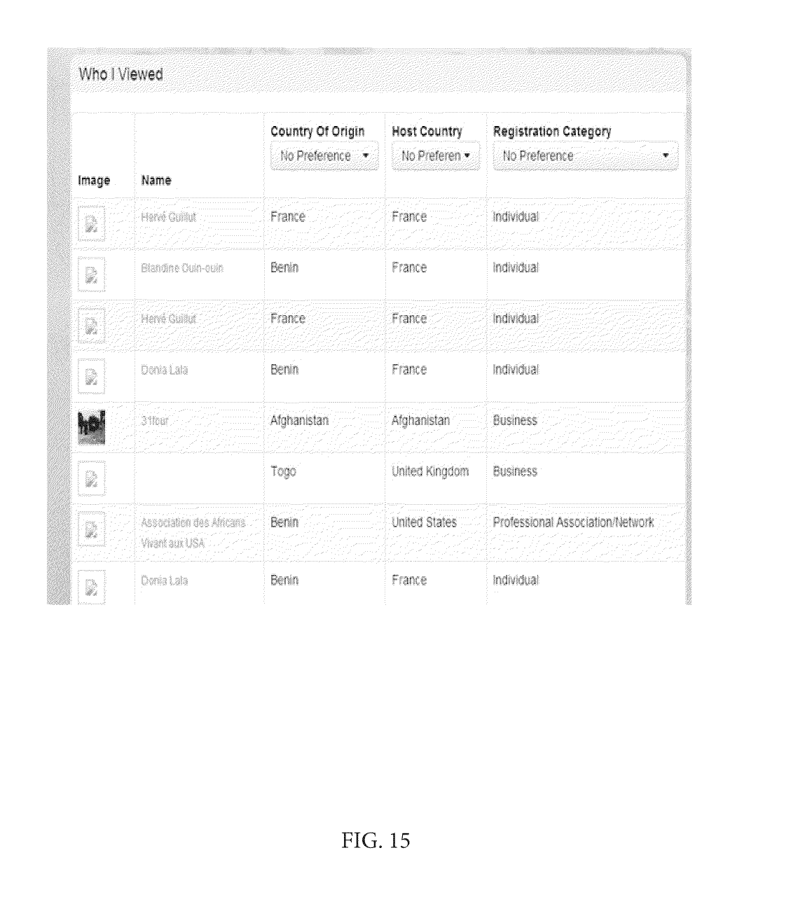

FIG. 16 is an illustration of a “who recently joined” page for the present invention.

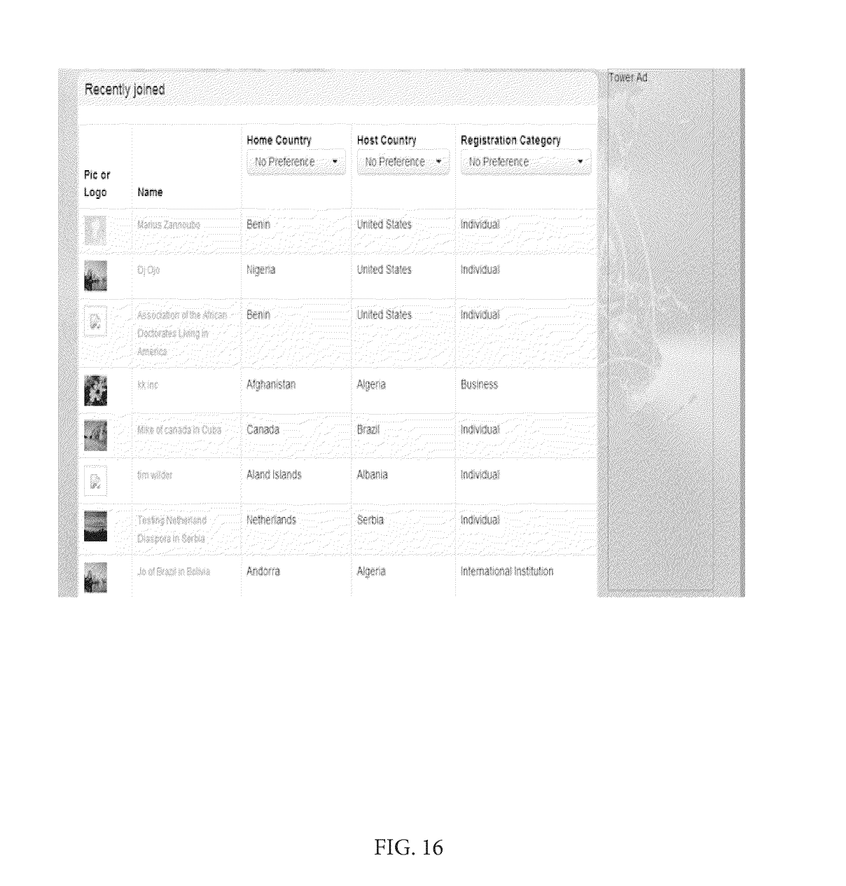

FIG. 17 is an illustration of the account page for the present invention, wherein the user can edit and update their registration information.

FIG. 18 is an illustration of the privacy settings for the present invention.

FIG. 19 is an illustration of the “change password” page for the present invention.

FIG. 20 is an illustration of the “update resume and company description” page for the present invention.

FIG. 21 is an illustration of the “invite friend” page for the present invention.

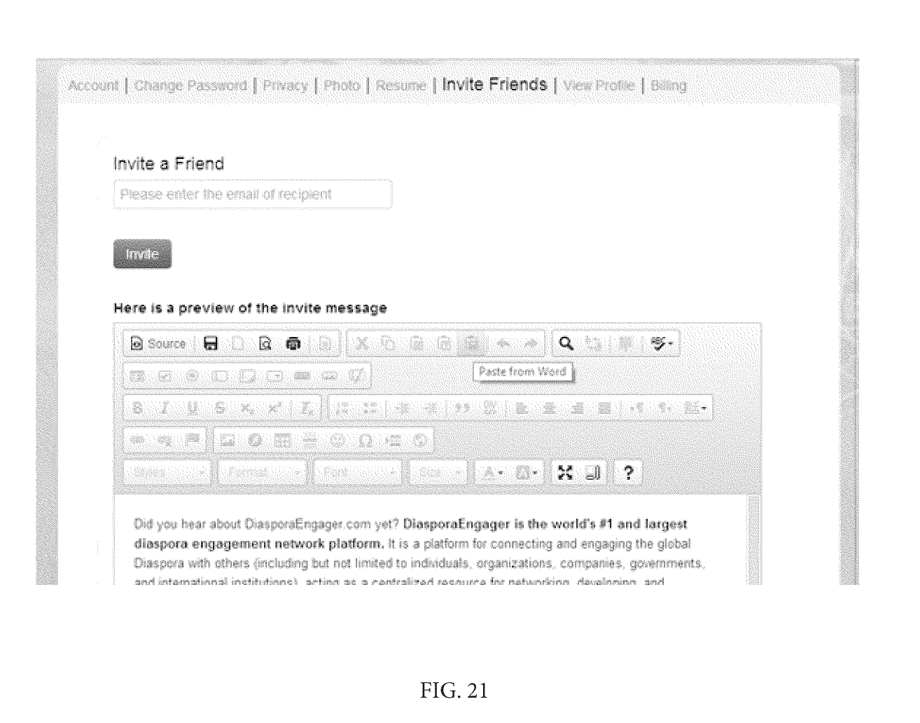

FIG. 22 is an illustration of the “group interface” page for the present invention.

FIG. 23 is an illustration of the “create group interface” page for the present invention.

FIG. 24 is an illustration of the “quick search for a group” page for the present invention.

FIG. 25 is an illustration of the “groups requests sent and requests received” page for the present invention.

FIG. 26 is an illustration of the “group search results” page for the present invention.

FIG. 27A is an illustration of a potential profile interface of the present invention.

FIG. 27B is a continuing illustration of a potential profile interface of the present invention.

FIG. 28 is an illustration of potential message interface of the present invention.

FIG. 29A is an illustration of a potential search interface of the present invention.

FIG. 29B is a continuing illustration of a potential search (for a date) interface of the present invention.

FIG. 29C is a continuing illustration of a selected potential search (for need/offer) interface of the present invention.

FIG. 30 is a diagram showing potential interactions between users of the present invention.

FIG. 31 is an outline illustrating users being connected to each other based on posted needs/offers.

### DETAILED DESCRIPTIONS OF THE INVENTION

All illustrations of the drawings are for the purpose of describing selected versions of the present invention and are not intended to limit the scope of the present invention.

The present invention is a website platform that is intended to connect a diaspora with their homeland and their country of residence, providing a common platform for disclosing the availability of needs and offers for resources. As a result, the present invention is able to act as a liaison between diasporas, including people and organizations, in both home and host countries. The present invention is designed to benefit a number of entities, examples of which include, but are not limited to, associations, networks, businesses, consultants and consulting firms, government agencies, immigrants, diaspora members, travelers, research institutes, laboratories, non-profit organizations, philanthropists and donors, recruiting agencies, professionals, retired persons, sales persons, educational institutions, faculty and staff members, students, travel agencies, the unemployed, and volunteers.

The objective of the present invention is to act as a liaison between all diasporas, including persons and organizations residing in home countries and host countries. The present invention aids these persons and groups in finding, harvesting, and transferring resources, services, and opportunities between users of the present invention. Ultimately, the present invention wants to help users connect with each other for mutually beneficial purposes, whether jobs, collaboration, donations, and more, such as adoption, advocacy, banking and insurance, benchmarking, brain drain management, business opportunities, capacity building (strengthening), career development, collaboration, consulting, cultural issues, dating services, democracy and governance, diaspora complaints, diaspora return to home country, diaspora representative, diplomacy, editing/editorial services, education, engineering, entrepreneurship, environmental services, extension services, fellowship services, foreign policies, forum discussion, fundraising initiatives, gender issues, general information, healthcare, recreation, housing services, human rights, immigrant integration, industry, infrastructure building, innovation, international affairs, investment, job search and placement, labor issues, legal services, lobbying, marketing, mentoring, networking, new challenges, immigrants assistance, new opportunities, news, peace and war, pen pal, philanthropy, policy development, refugees services/assistance, science and research, security, spirituality, survival skills, talents recruitment, teaching, technology, town twinning, translation services, transportation, tutoring, and volunteering. The above list is not exhaustive, as the present invention can focus on additional areas of interest.

The present invention serves to connect users (which can be individuals, business, organizations, and even governments) across the world. While the present invention is designed to provide resources for the benefits of diaspora, as well as their home and host countries, the present invention can be used by any person. In fact, while the term diaspora is commonly defined as a person living in a country or town separate from their place of origin or ancestry, the present invention defines the term diaspora as any human being. Going back far enough along their family tree, most persons can be linked to a country of origin different than their country of residence, even if their family has been living in the same country for generations. These people forget that ultimately they too are immigrants to their country, and unfortunately treat new immigrants as “bad people” or “taking our land or our country”. But, ultimately, these new immigrants are just trying to go through the obligatory survival and integration steps that the ancestors of current residents had to go through. To some extent, because some religious people see themselves as strangers (diaspora members) on this planet earth, they seek to go to a better country to come very soon: heaven. Other people do not even know where they come from or where they are going sooner or later. Thus, without entering any political, religious, and demographic debates, the present invention applies the word “diaspora” to any human being.

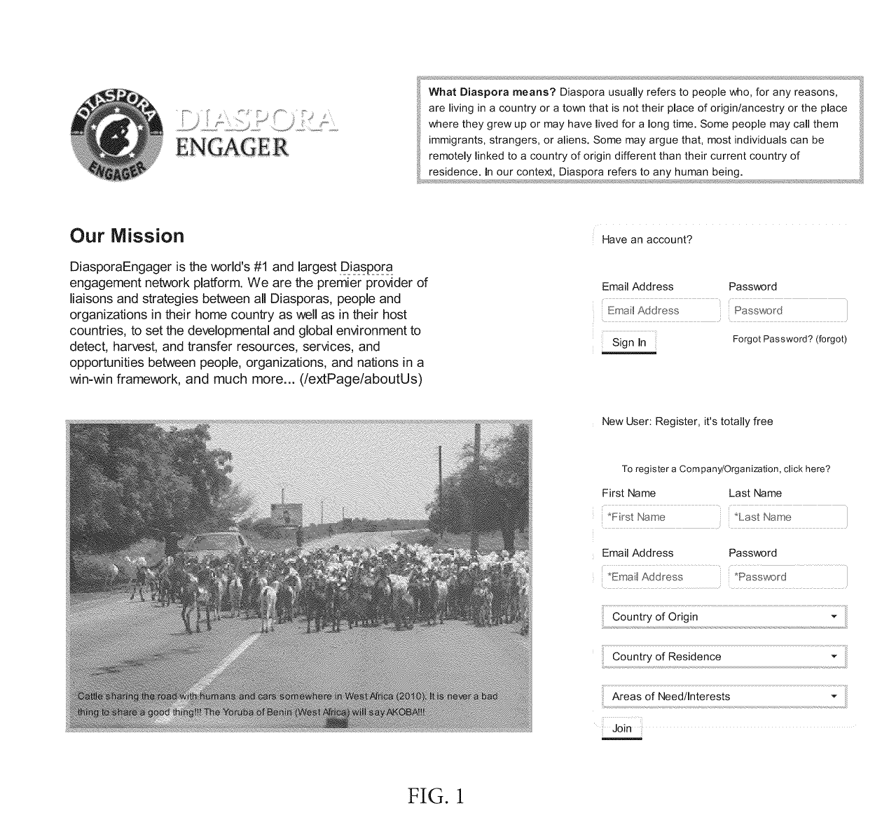

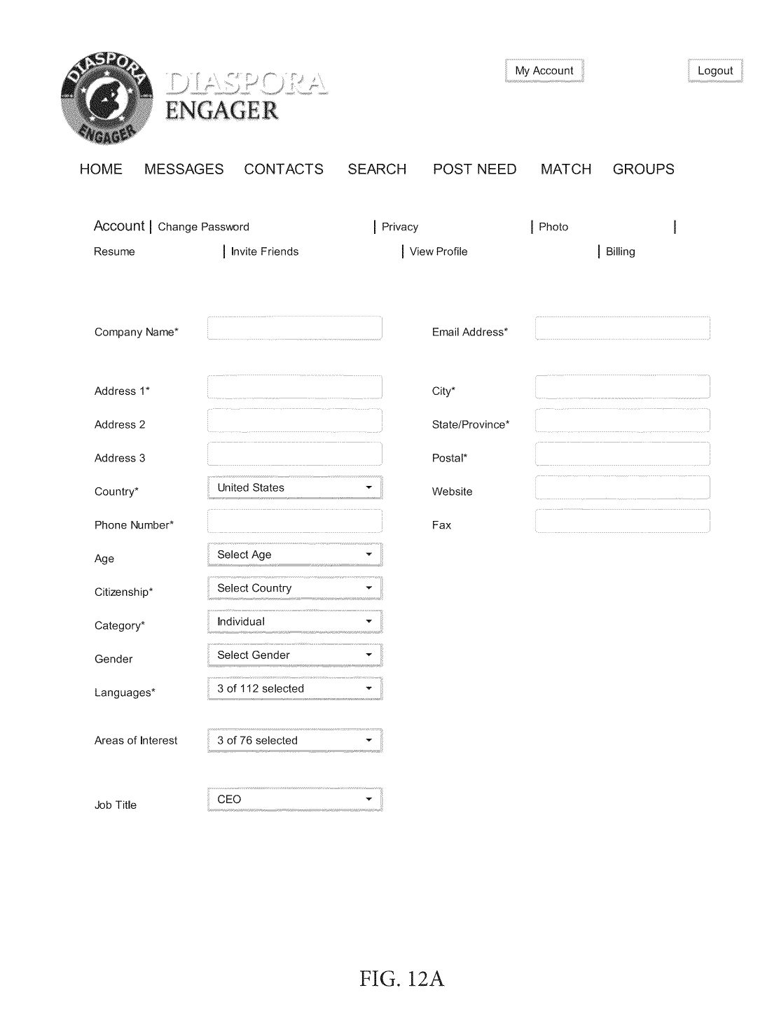

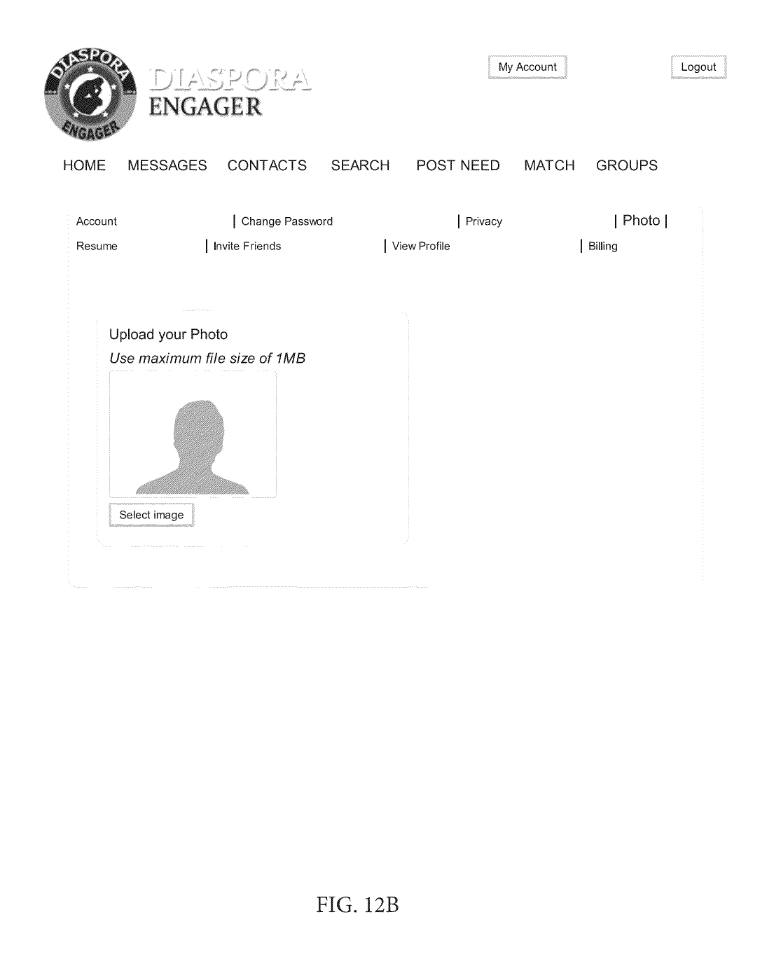

The present invention provides several resources to help diaspora, but to take advantage of the present invention and its resources, a user must first register a user account. Overall, the present invention is used to manage the interactions between a plurality of user accounts, and these interactions between the accounts will improve the situation created by diasporas. An arbitrary account refers to any account within the plurality of user accounts. The registration process requires a prospective user to provide an email address, to which a confirmation link is sent. An illustration of an interface linking to registration is provided in FIG. 1. The user can then follow the confirmation link to continue with the registration process. The use of a confirmation link acts as a barrier against spam programs which may try to create a number of fake accounts for the purpose of self promotion or malicious acts. After being provided with the confirmation link, a prospective user is redirected back towards the main website of the present invention, where the prospective user fills out several fields including but not limited to those shown in FIG. 12A and FIG. 12B that form the basis of the user's profile information. Information collected during the registration may include, but is not limited to: name, username and password, address, zip code or area code, telephone number, country of residence, country of origin, country of citizenship, age, gender, language preference(s), duration of residence in home country before moving, tribe or culture, education completed, job title, field of expertise, occupation, number of years of experience, resume or curriculum vitae, memberships, dating information (if applicable), areas of need and interest, logos or photos of an organization/individual, descriptions of an organization, and information about a user's matches preferences.

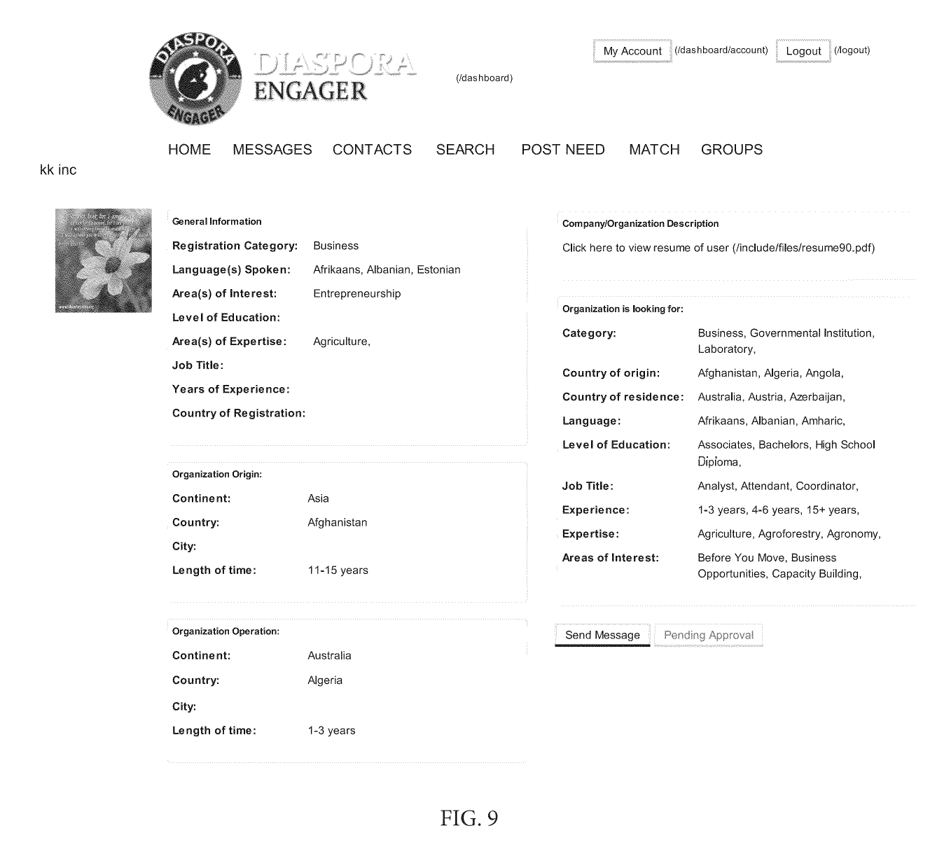

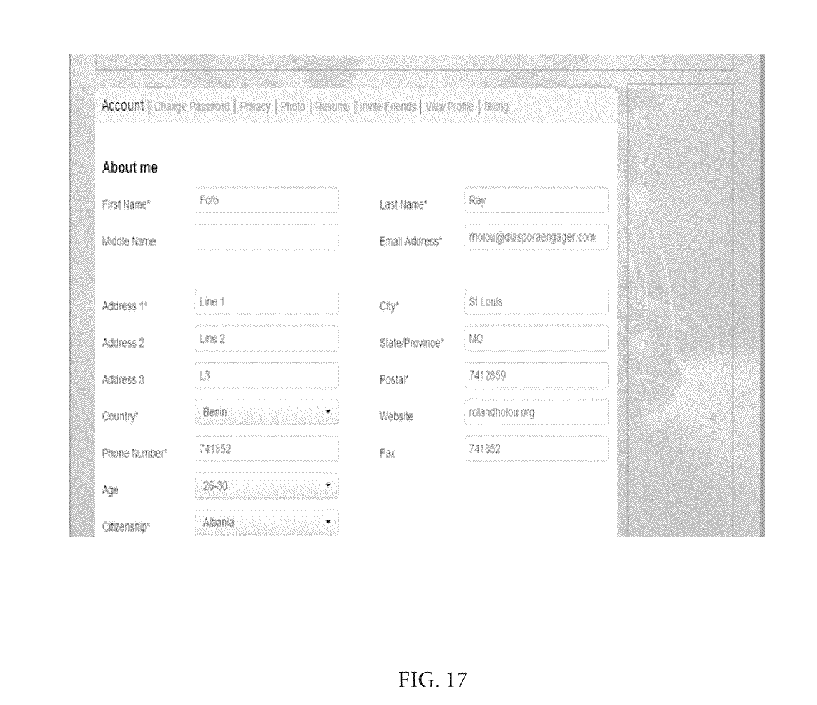

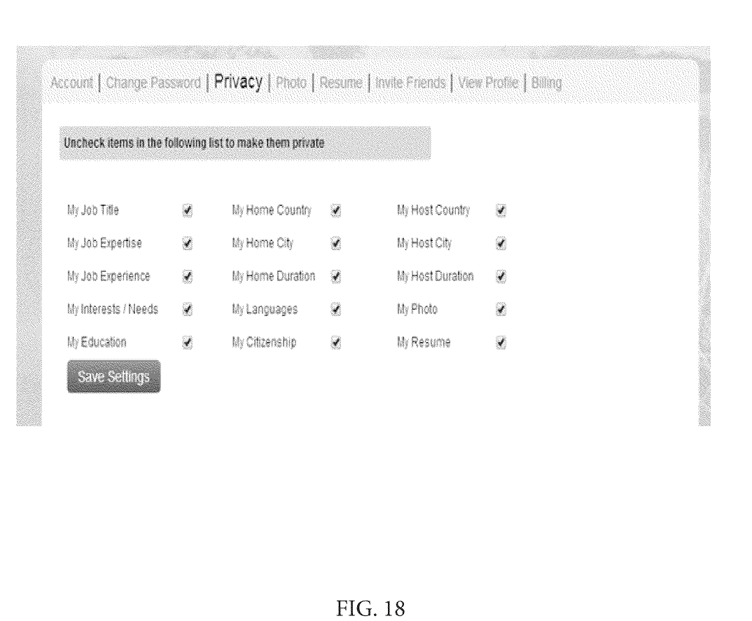

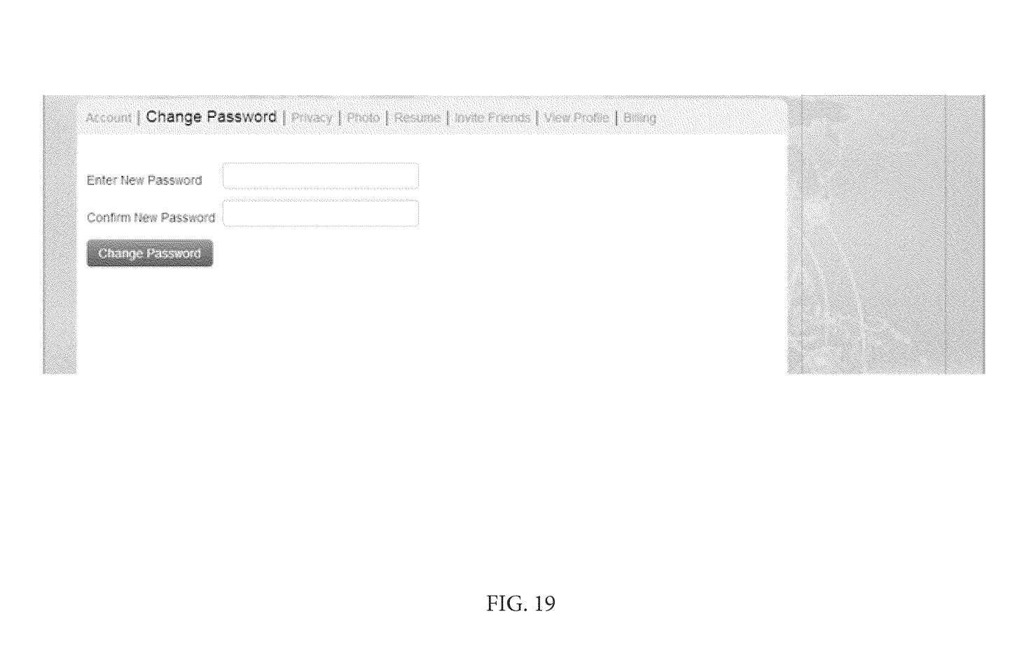

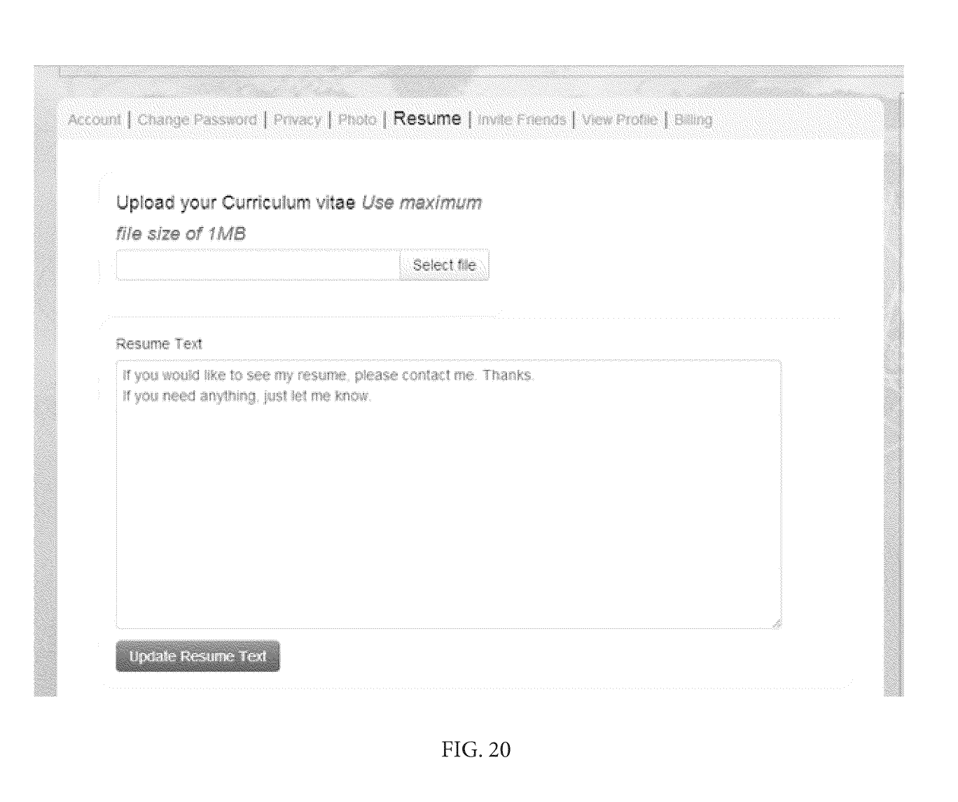

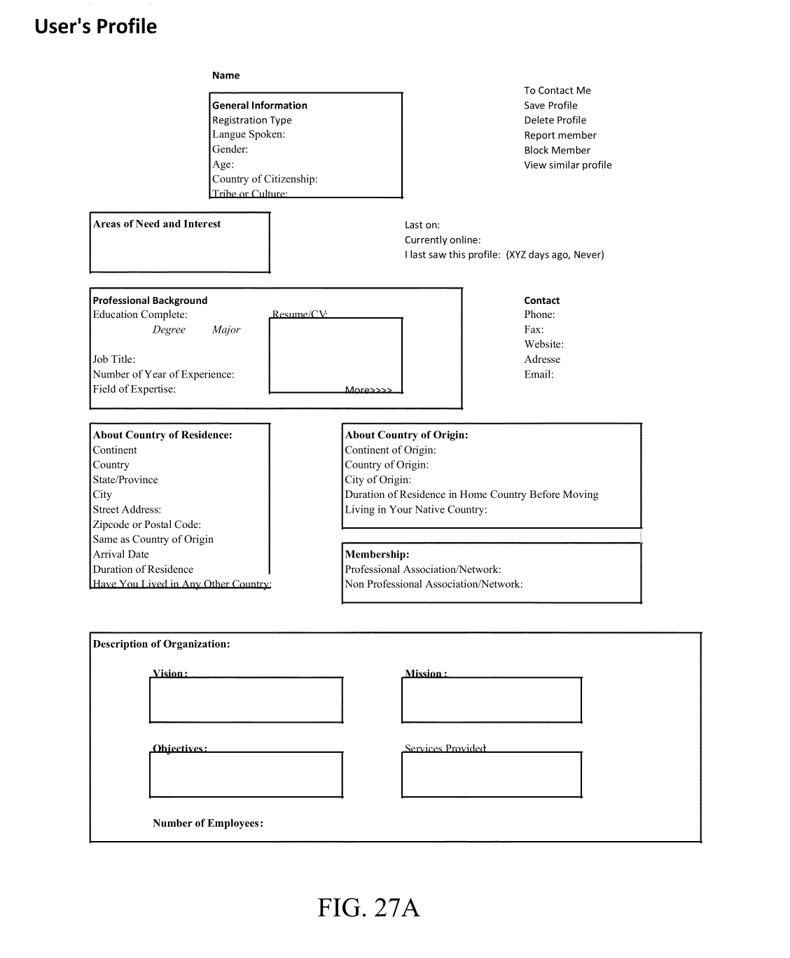

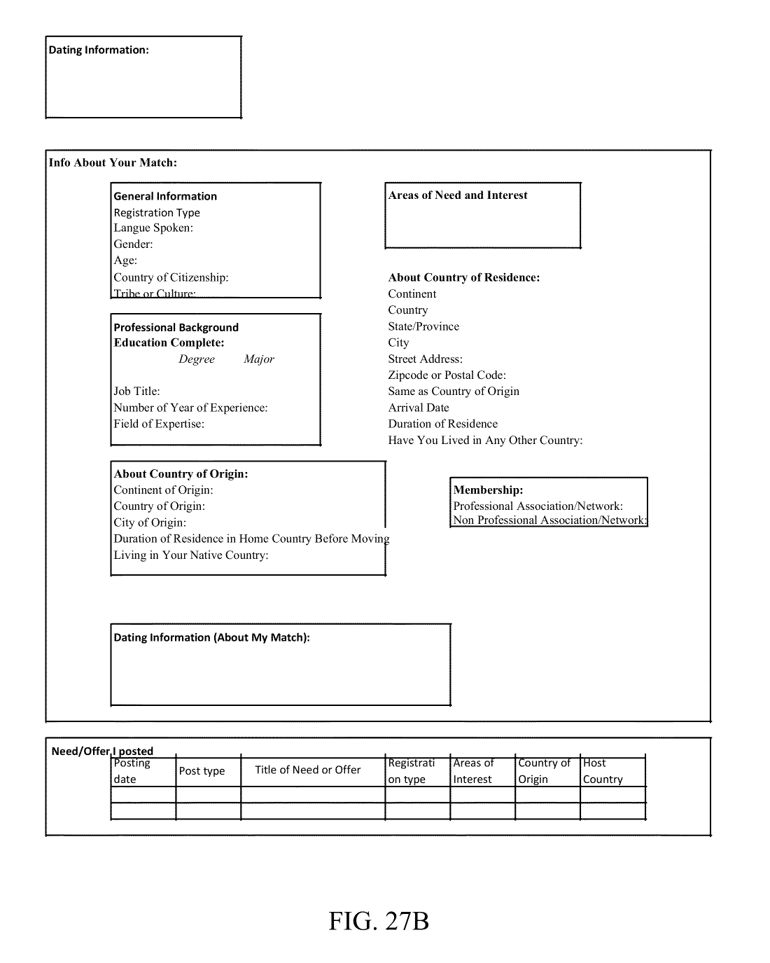

The collected information is then used to create the user's profile, such as shown in FIG. 9, FIG. 27A and FIG. 27B. Most importantly, the user's profile information includes their residence location, which is current residence of the user, and their origination location, which is the area he/she originated from. The residence location and the origination location for each user profile allow the present invention to optimize interconnectivity between user accounts with similar residence locations and with similar origination locations. Moreover, the user has the option to change privacy settings (FIG. 18), controlling who is able to access the user's profile information. Access to each information field can be individually controlled; for example, a user may choose to keep their age and dating information private, but have their education, job title, field of expertise, and resume visible to the public. The present invention allows the user to edit and interact with their user profile through the graphic user interface as can be seen in FIGS. 17, 19, and 20.

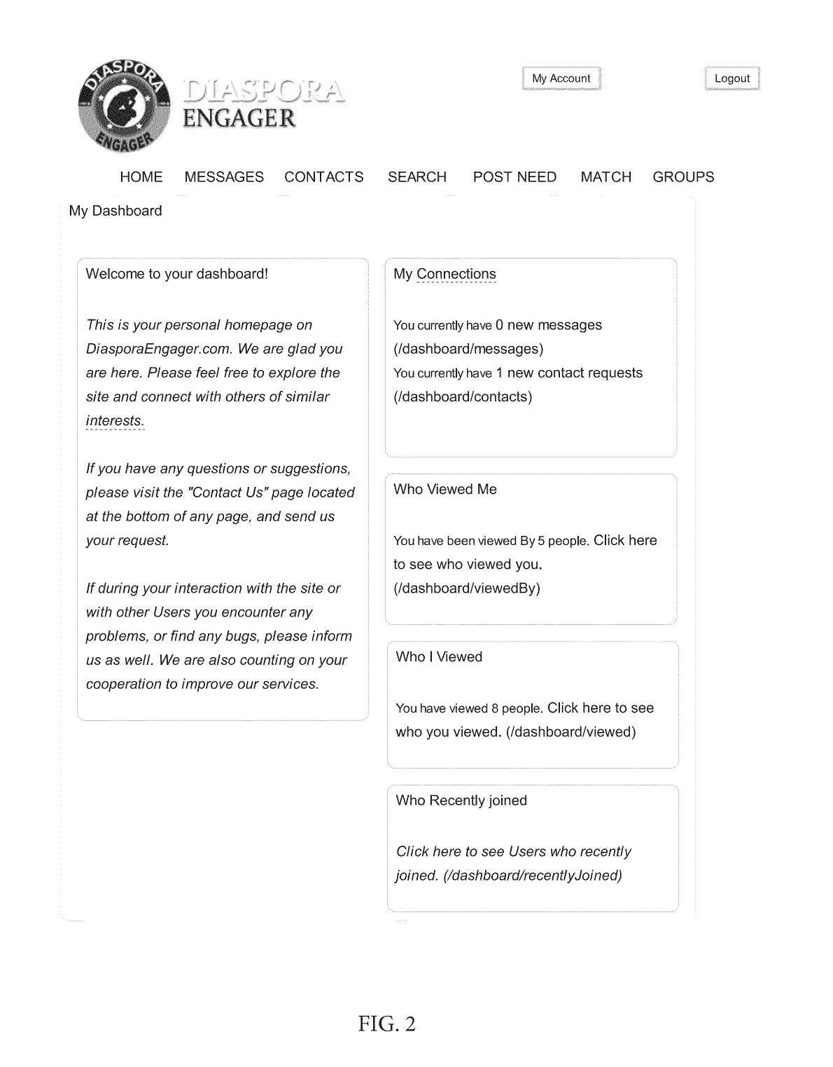

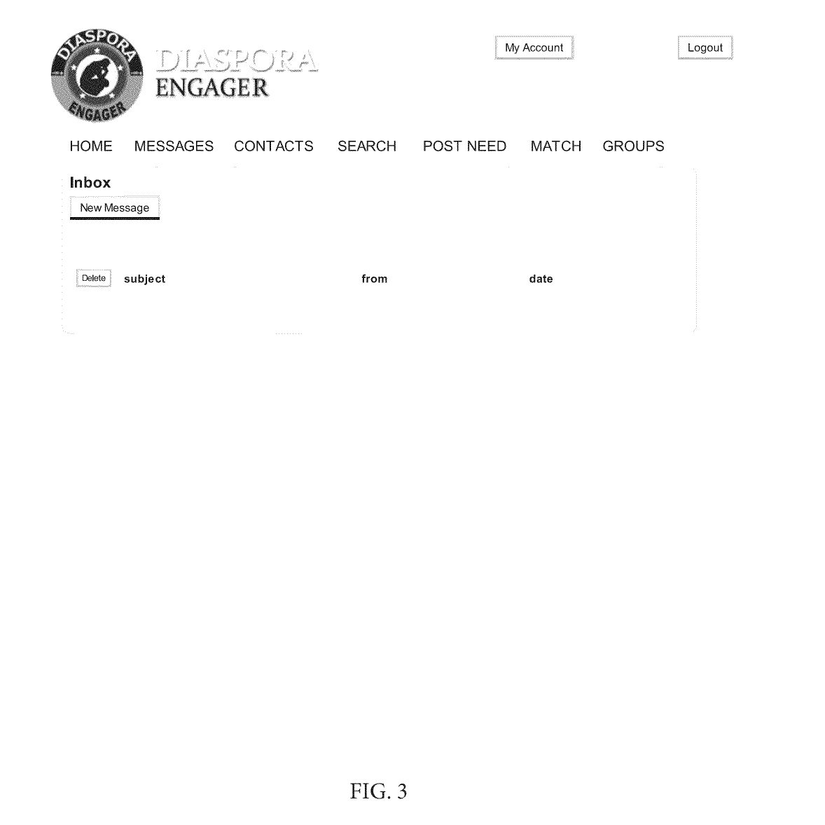

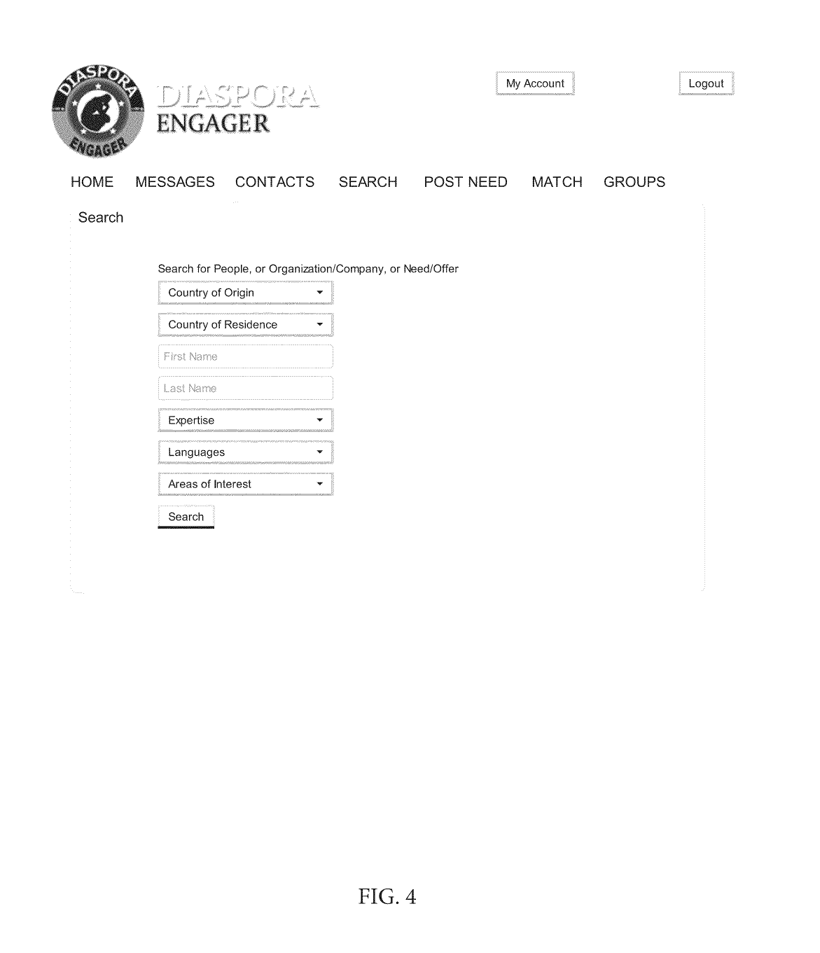

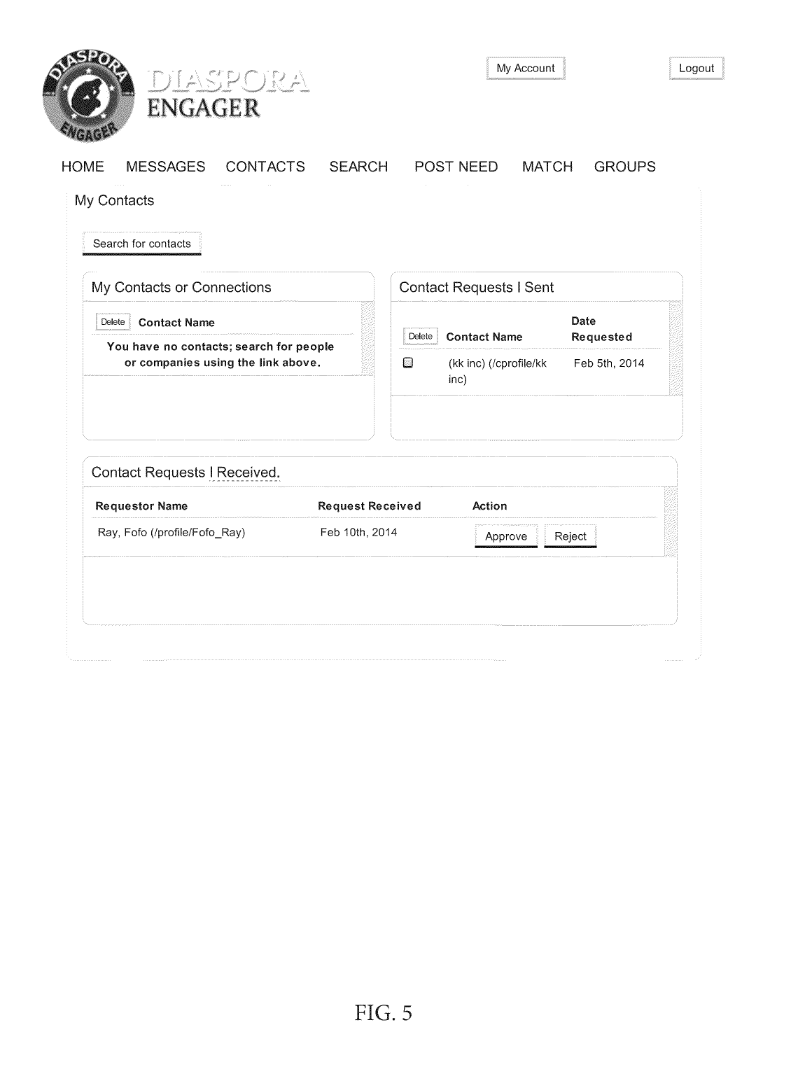

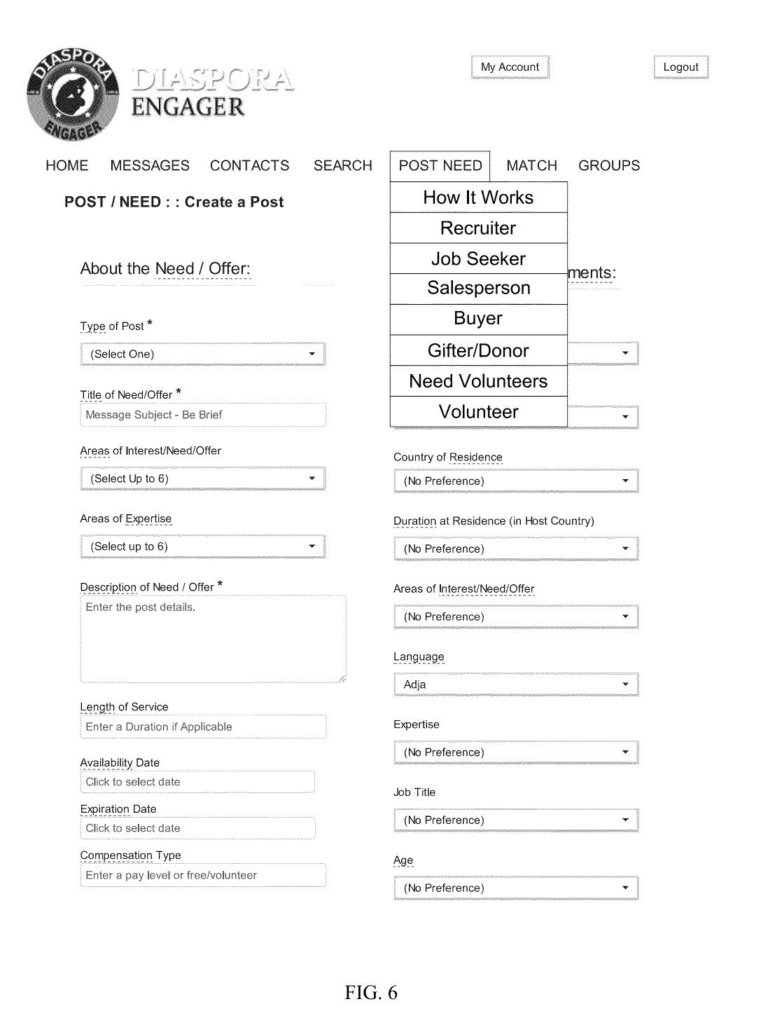

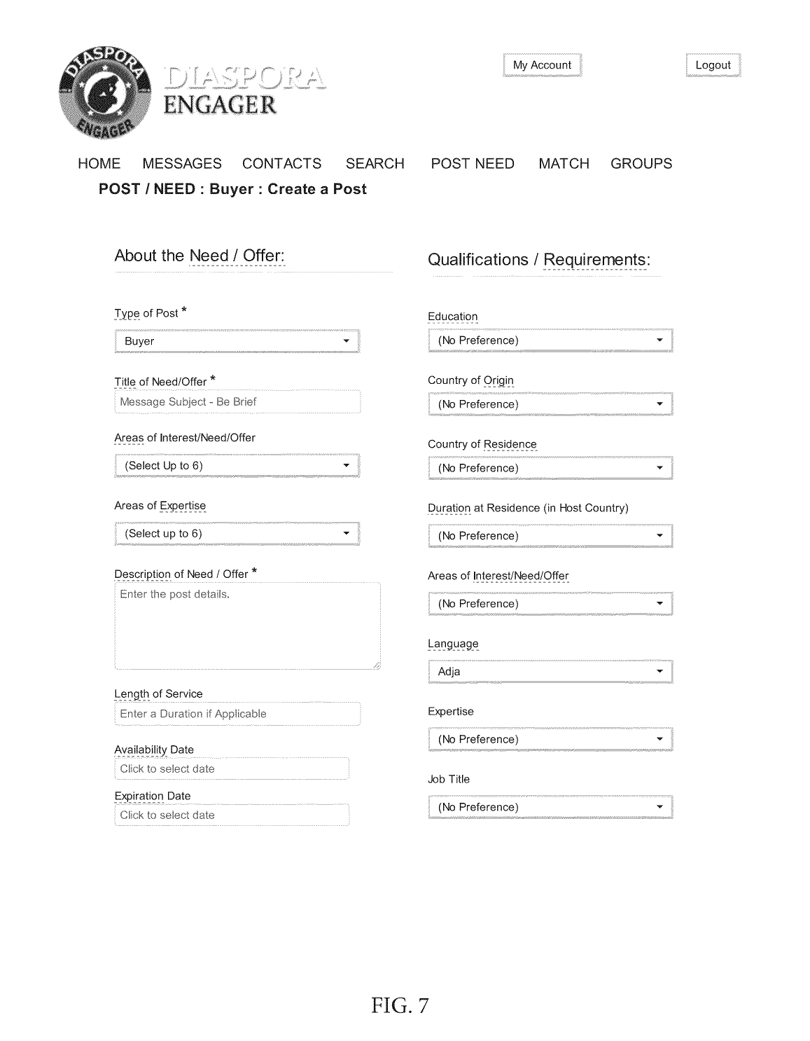

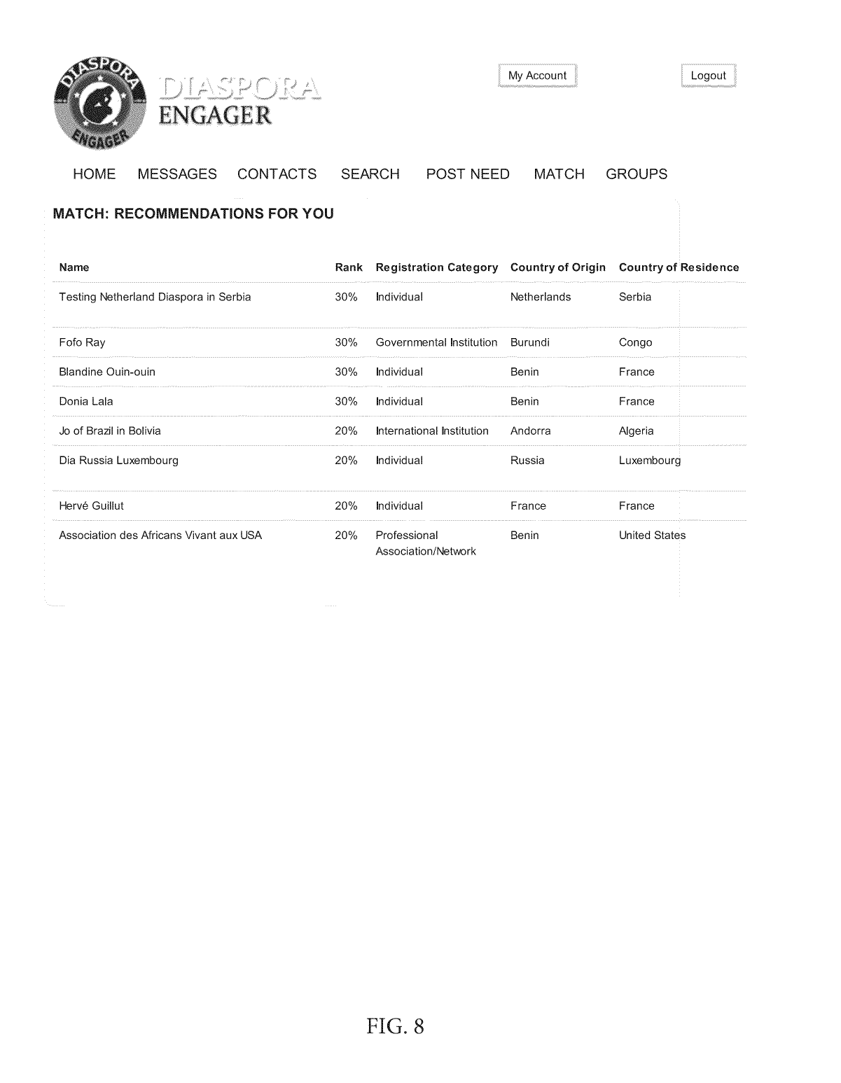

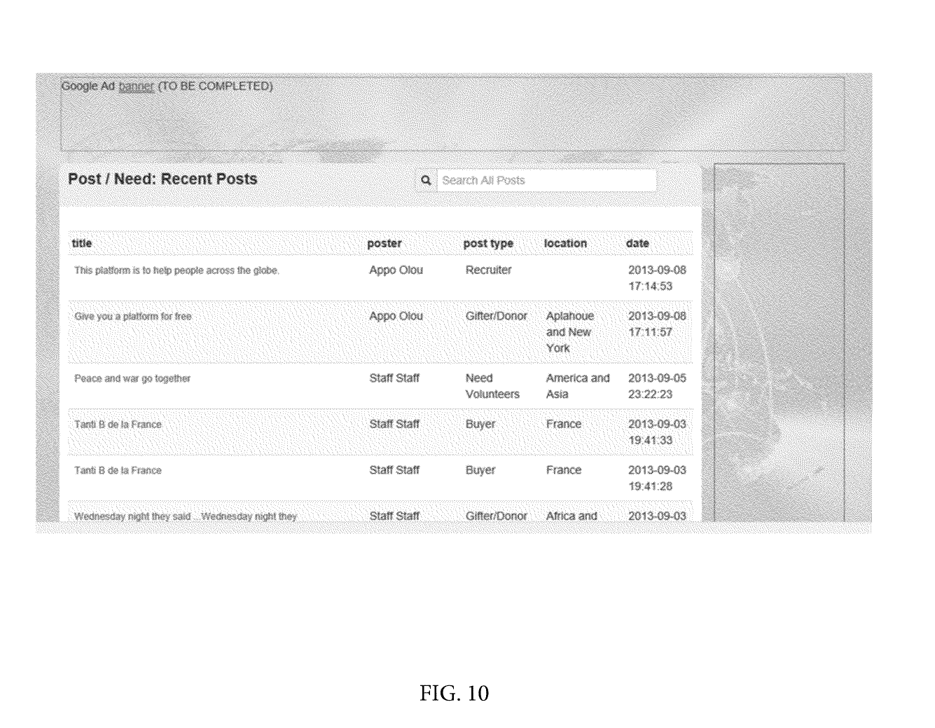

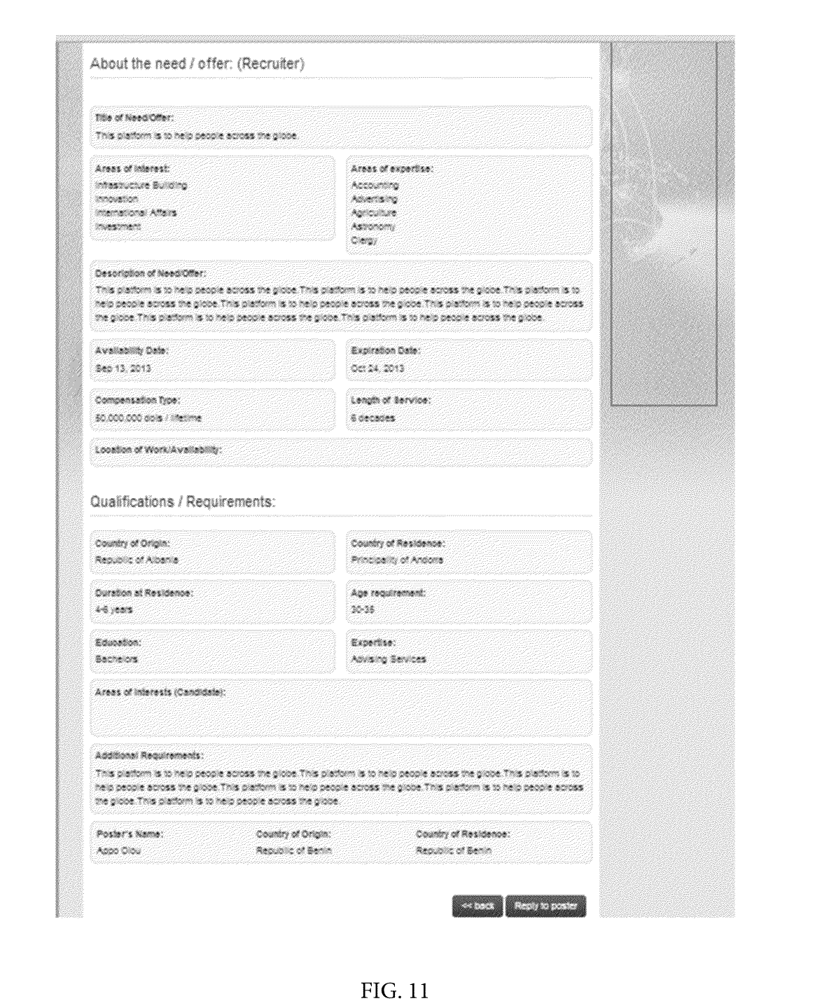

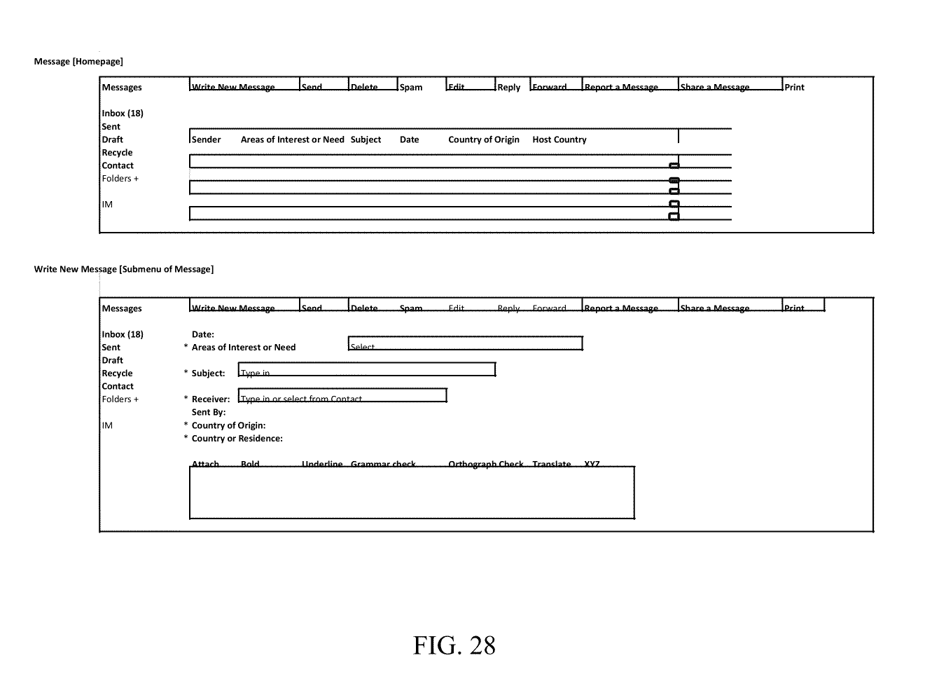

After creating their account and setting up their profile, the present invention enables a user to access a plurality of communication resources. The user can access the communication resources through a graphic user interface that includes a home page and dashboard such as shown in FIG. 2. The dashboard is the default pages users are directed to after loading in, unless they are a new user in which case they must first go through the account creation process. From the dashboard, users are able to access the other sections of the present invention, such as messages, contact lists, search functions, matches, groups, and the user profile. Any notifications the user receives, such as for new messages or relevant opportunities, will be posted to the dashboard. While many possibilities for communication resources exist with the present invention (such as the following: sending and receiving messages (FIG. 3, FIG. 28); searching (FIG. 4); viewing, managing, and organizing contacts (FIG. 5); and creating and interacting through a plurality of networking groups), a key feature is the ability of a user to post needs, offers, or both to a common board that can be seen by other users of the present invention. Several interfaces related to posting or finding needs or offers are shown through FIG. 6, FIG. 7, FIG. 8, FIG. 9, FIG. 10, and FIG. 11. Needs and offers can be posted by any user of the present invention, at which point the poster will classify the need/offer with a “category type”. A non-comprehensive list of category types for need/offer posts is as follows: recruiter, salesperson, job seeker or job applicant, buyer (someone who wants to buy a product or service), want to volunteer, requesting volunteers, philanthropist or donor, receiver, and other.

The category type allows users to more easily sort through and filter the available need/offer posts. After choosing a representative category type, information relevant to the need/offer is provided. The information requested to post a need/offer may include, but is not limited to, the following: a title of the need/offer, a descriptive summary, a field of expertise of the need/offer, an areas of interest of the need/offer, a length of service if applicable, an availability date of the need/offer, an expiration date of the need/offer if applicable, and a compensation type.

To better control the responses to a need/offer post, a poster can enter requirements or restrictions that must be met by another user to respond to a need/offer post. Some sample qualifications are as follows: registration category (e.g. individual, business, nonprofit, school, government agency, immigrant, consultant, etc.), country of origin, country of residence, duration of residence in host country (if an individual), areas of interest, language preference(s), profession, field of expertise, job title, and age (of an individual).

If a need/offer post is for a gift, then additional information may be requested, such as the type of gift or service, the cost of the gift, the value of gifted goods or service, the delivery route, and any additional information that the poster may consider relevant. After the user fills out description information for the need/offer post, the present invention automatically attached the name, the areas of interest, the home and host country of the user (e.g. person or institution) posting the need or offer. Once the user has filled out the information and the need/offer post, the present invention will be visible in several places; the need/offer post will be listed in a general database of the present invention, will be shown on the profile page of the poster, and will be shown as a search result for search engines of the present invention.

More specifically, each of the need/offer post on the common board has a category type, user information, description information, and location information. When a user wants to add a specific need/offer post, the present invention will prompt the user to select a category type. The present invention also extracts user information from the user profile of the arbitrary account, which will allow whoever that reads the specific need/offer post to identify the poster. The present invention will then retrieve description information and location information for the specific need/offer post by prompting the user to enter those pieces of information through the graphic user interface. Once the specific need/offer post is completed, the present invention will add the specific need/offer post with the category type, the description information, and the location information to the common board so that the specific need/offer post can viewed by the rest of the users.

Moreover, the present invention follows a process while filtering responses for a specific need/offer post. When a user wants to restrict access to their specific need/offer post, the present invention will retrieve qualification information for the specific need/offer post from the user, which the user can enter through the graphic user interface. The present invention will then compare the qualification information to the user profile for each of the plurality of user accounts in order to determine suitable accounts from the plurality of user accounts. Consequently, the present invention enables access to the specific need/offer post to these suitable accounts through the common board.

In addition, the present invention follows a process which allows a user to search for a specific need/offer post on the common board. The process begins by retrieving search criteria for the specific need/offer post through the user, which can be done through the graphic user interface. The process continues by comparing the search criteria to the category type, the user information, the description information, and location information for each of the plurality of need/offer posts on said common board, which allows the present invention to determine matching posts on the common board. The present invention will then display each of the matching posts through the graphic user interface to the user, which allows the user to look through the matching posts. The process continues by prompting the user to select the specific need/offer post from the matching posts in order to view more detailed information on the specific need/offer post or to remove the specific need/offer post from the common board.

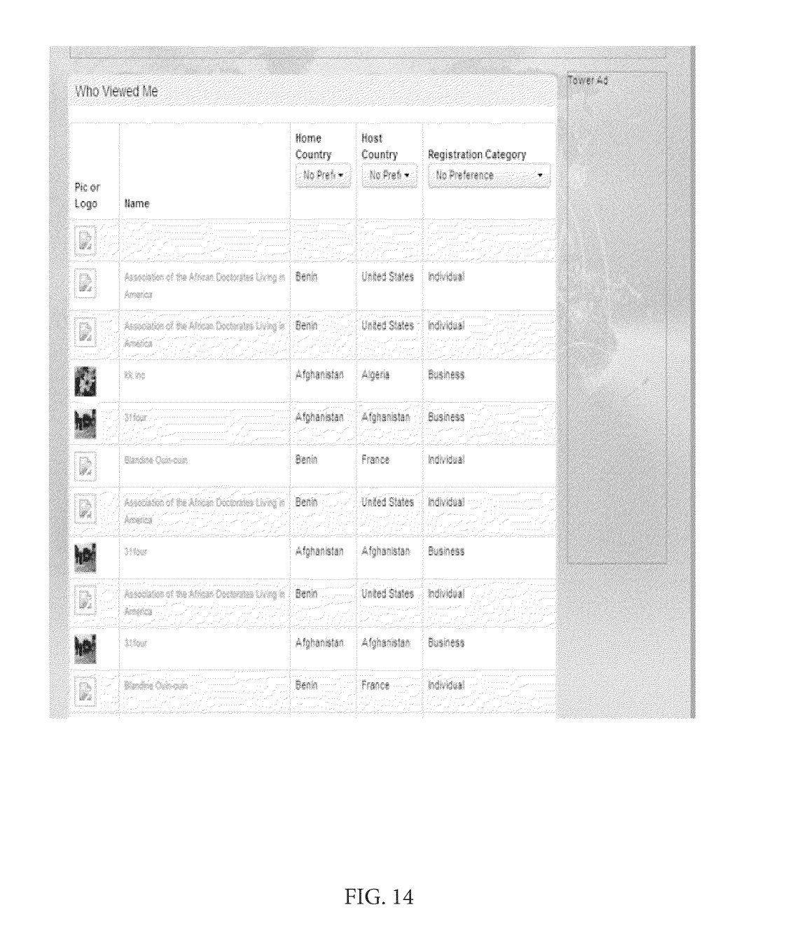

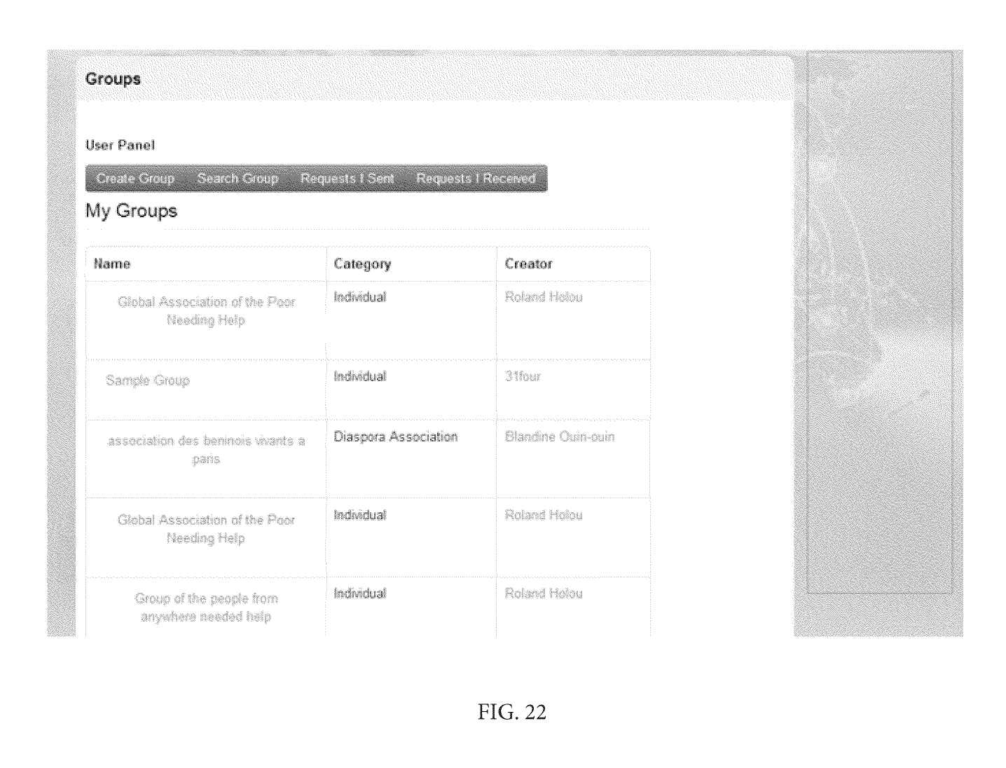

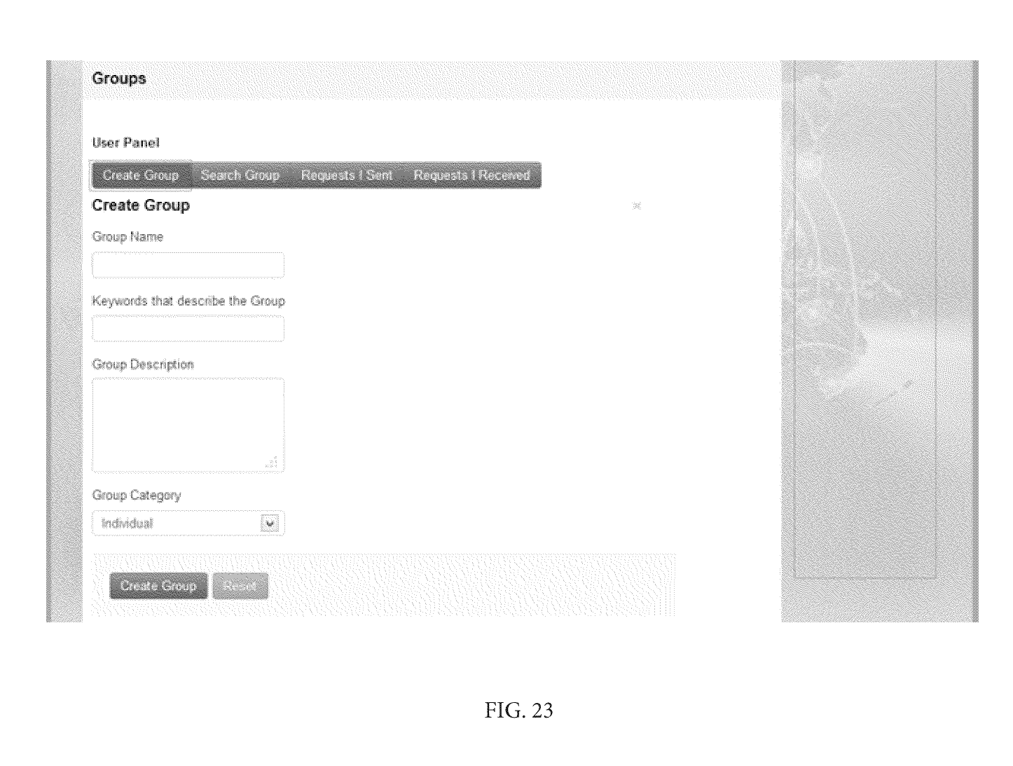

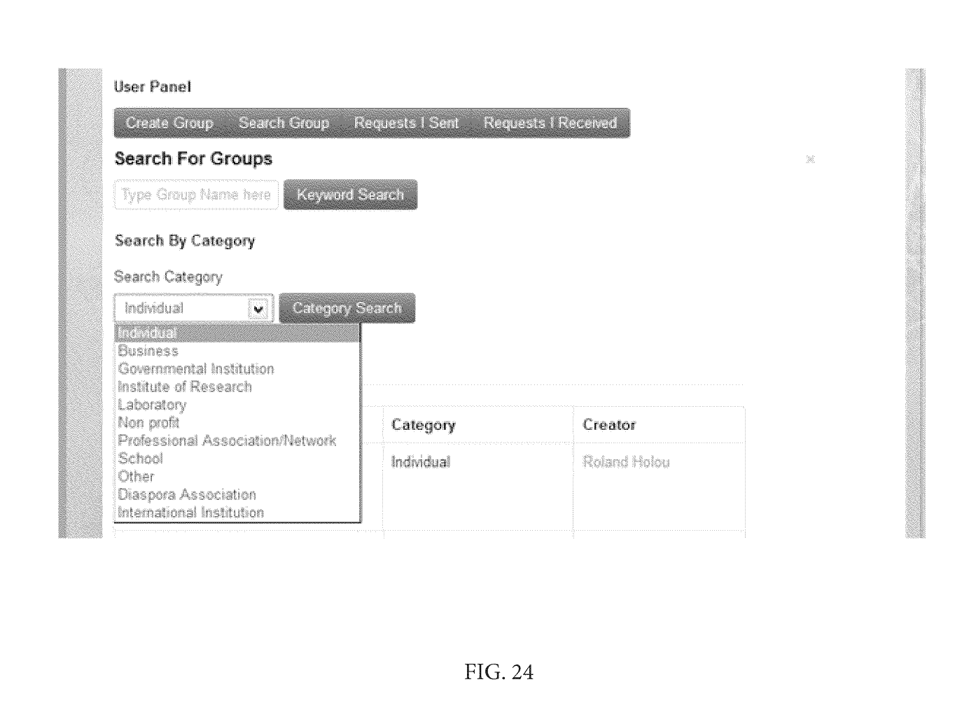

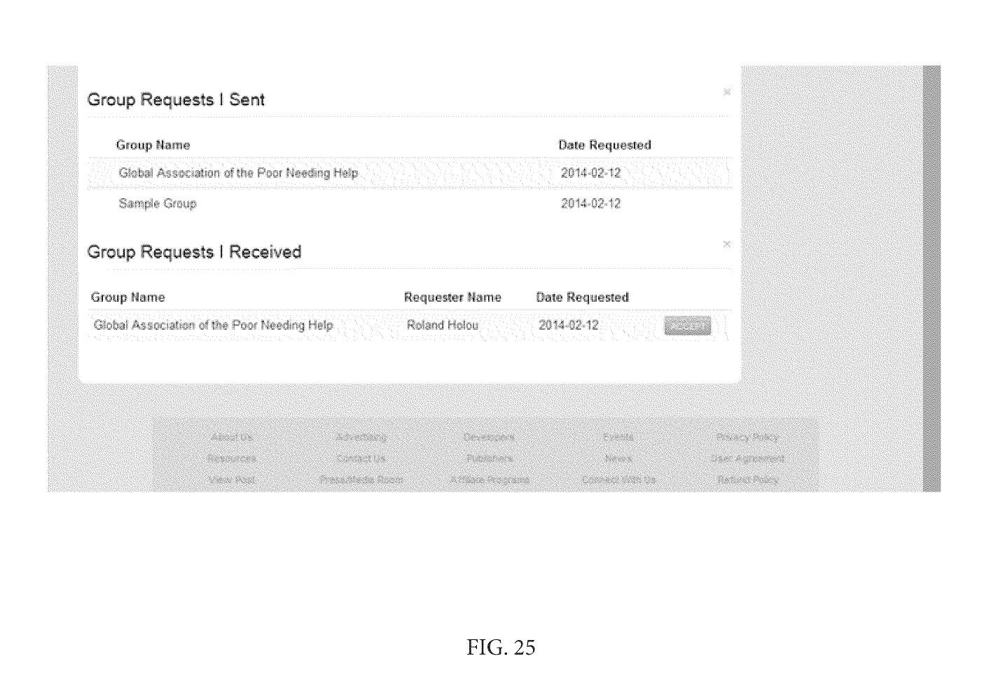

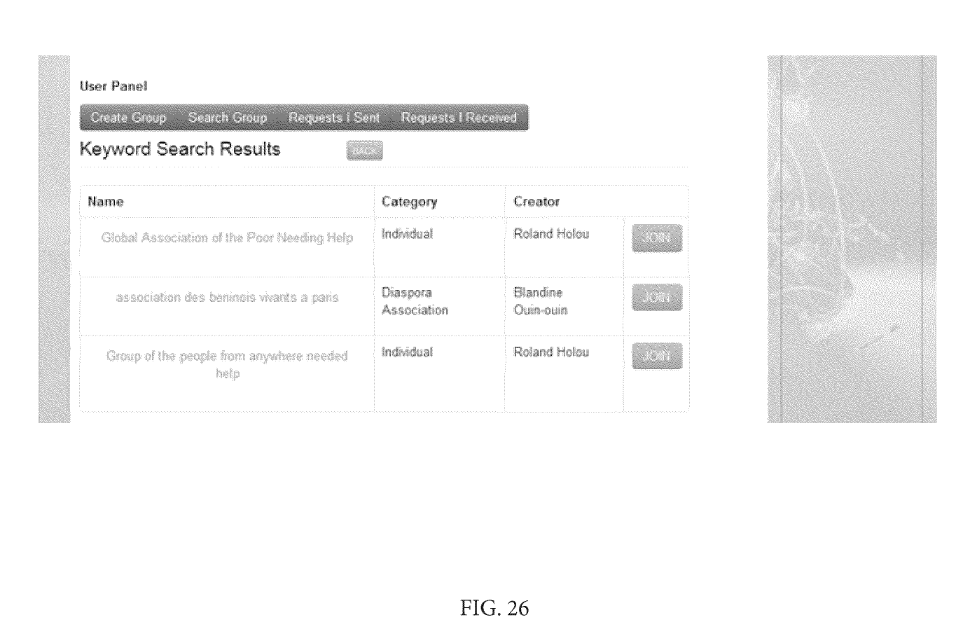

In addition to connecting users through the plurality of need/offer posts, the present invention allows users to engage each other through other methods, such as creating networking groups and finding new contacts. Each user can manage and add to their contacts list so that the user can network with new and different contacts. As illustrated in FIG. 14, 15, 16, 17, the present invention tracks what user profiles each user has looked up and share that information with other users so that new contact for each can be found. Networking groups can be created for a variety of purposes, bringing together members with a common cause or interest and allowing the group members to better network with others, ultimately benefitting diaspora in both the home and host country. A non-comprehensive list of category types for network groups is as follows: individual, business, governmental institution, research institution, laboratory, non-profit organization, professional association/network, school, other, diaspora association, and international institution. A user can manage their interactions with networking groups through the graphic user interface as can be seen in FIGS. 22, 23, 24, 25, and 26.

More specifically, the present invention follows a process that enables a user to view, organize, and manage their contacts list. The process begins by displaying their contacts list to the user through the graphic user interface. The present invention also prompts the user to select a piece of sorting information from the typical user profile such as a name, residence location, or origination location. When the user selects a piece of sorting information, the present invention will organize the user's contacts list according to that piece of sorting information. In addition, the present invention prompts the user to select a specific contact from their contacts list. When the user selects the specific contact, the present invention will display the user profile of the user account that corresponds to the specific contact.

More specifically, the present invention follows a process to create a specific networking group amongst the other users. The process begins by prompting a user to select a category type for the specific networking group that the user wants to create. The present invention will then retrieve description information for the specific networking group from the user. The description information is the common interest that is shared by all of the group members. The present invention will then prompt the user to select other users to join the specific networking group. The process continues by sending join-requests for the specific networking group to those other users. Finally, if those other users accept their join-requests, then the present invention will add them to the specific networking group.

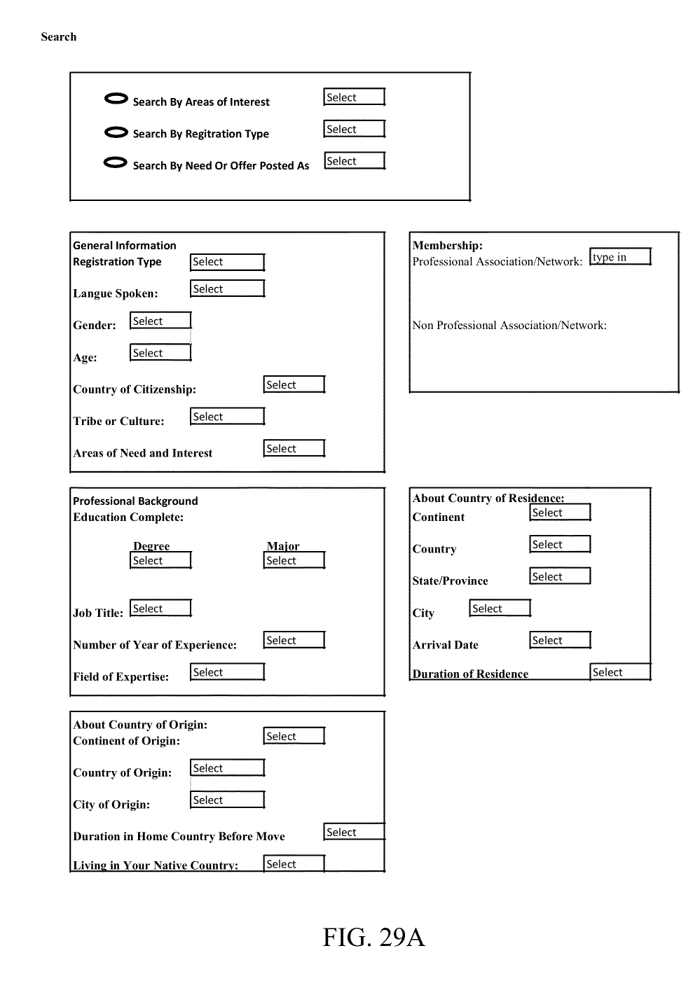

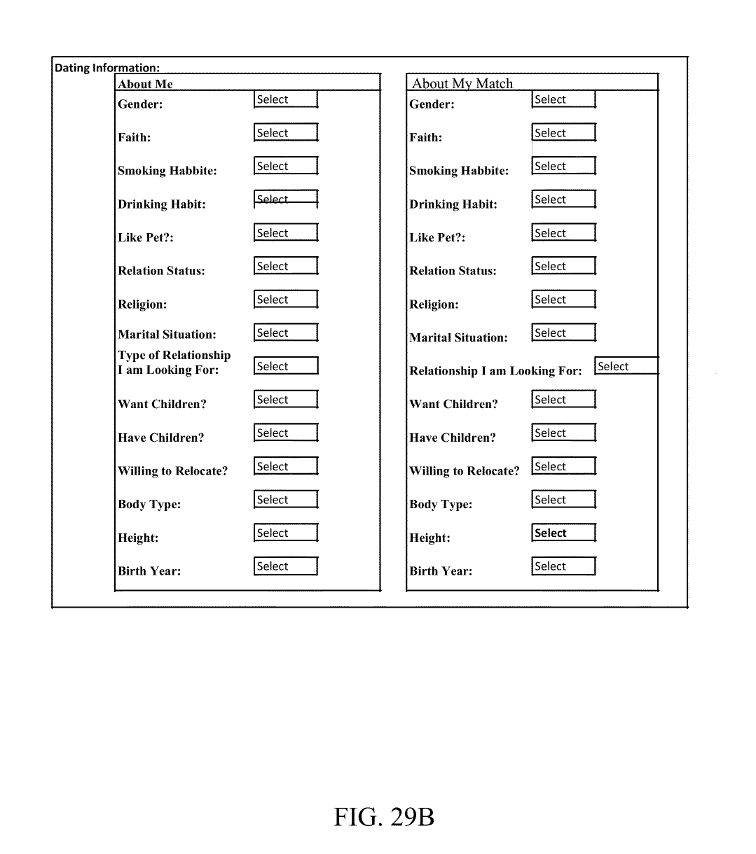

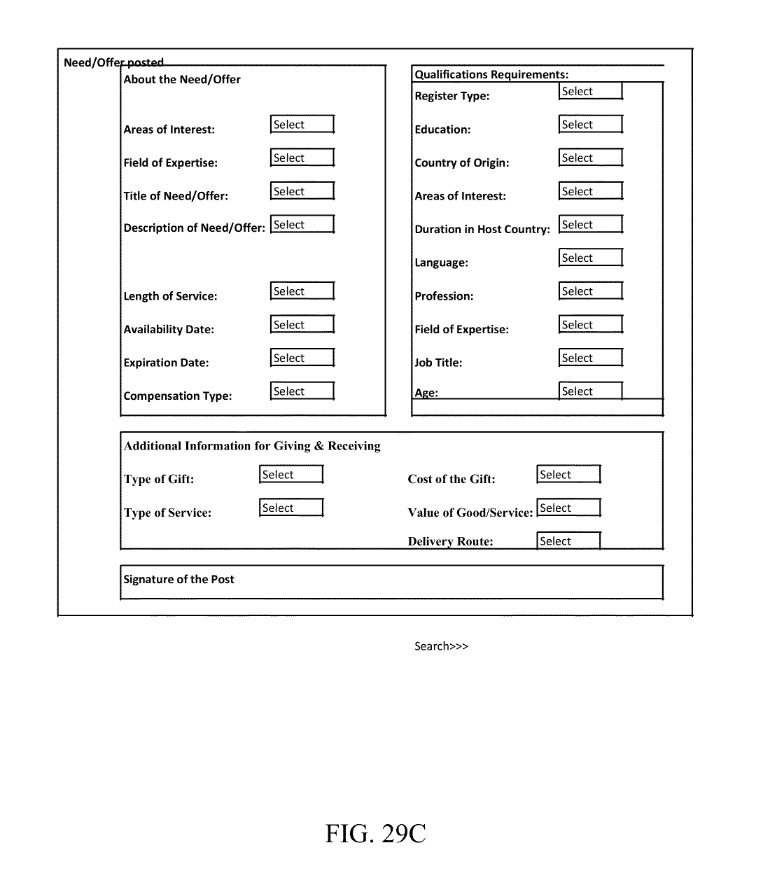

To find these new contacts and networking groups, a user may search for other users to interact with, either looking for a specific person (perhaps someone the user met in their new host country) or someone who matches the user based on registration preferences (e.g. someone in a host country with the same country of origin and profession). The search function, as shown in FIG. 29A, FIG. 29B, and FIG. 29C, can be used to connect with other users for a variety of purposes, such as discussing needs/offers or dating.

More specifically, the present invention follows a process to search for and add new contacts to a user's contacts list. The process begins by retrieving search criteria for the new contacts from the user. A non-comprehensive list of possible search criteria for new contacts is as follows: country of origin, country of residence, first name, last name, organization name, expertise, languages, and areas of interest. The process continues by then comparing the search criteria to the user profile of each user in order to determine a set of matching users. The user looking for new contacts will be prompted by the present invention to select their new contacts from the set of matching users found in the comparison step. The present invention will then send join-requests to the new contacts from the user. If the new contacts accept the join-requests, then the present invention will add the new contacts to the user's current contacts list.

Also more specifically, the present invention follows a process that enables a user to search for and join a specific networking group. The process begins by retrieving search criteria for the specific networking group from the user. The search criteria for networking groups could just be a keyword. The process continues by comparing the search criteria against each of the networking groups that currently exist on the present invention, which allows the present invention to determine a set of matching networking groups. The present invention will then prompt the user to select the specific networking group from the set of matching networking groups found in the comparison step. The process continues by sending a join-request from the user to the specific networking group. If the specific networking group decides to accept the join-request, the present invention will add the user to the specific networking group. If a user is accepted by the specific networking group, then the user will appear in their group-members listing, which then allows the user to find and interact with other members of the specific networking group.

The present invention enables users to send and receive messages amongst each other. The present invention implements one process to send messages and implements a different process to receive messages. The process of sending a message begins by prompting the user to select a specific contact from their contacts list because the message cannot be sent to someone not on their contacts list. The present invention will then prompt the user to compose the message through the graphic user interface and will consequently retrieve the subject and the content of the message through the graphic user interface as the user types into the designated areas of the graphic user interface. The present invention then extracts user information from the user profile of the user creating the message. The user information does not need to include the user's entire user profile, just the necessary information that allows whoever is reading the message to identify the user. The present invention will then add the user information to the message and send the message to the specific contact.

The process of enabling a user to receive a new message from another user only happens if the sender is on the contact list of the recipient user. The present invention will then notify the recipient user of the new message from the other user. The user can read the new message because the present invention will display the subject and the content of the new message and display the user information for the other user to the recipient user. The new message is displayed to the recipient user through the graphic user interface.

By means of the needs and offers section, the present invention helps international diaspora find and engage with each other, benefitting both members and their respective communities. The present invention allows users to find and connect with individuals and organizations that may be of interest to the user, filtering matches based on a number of criteria such as country of origin and country of residence. As a user adds need/offer posts to the common board, the posting are immediately made available to other users of the present invention, allowing the user to reach a worldwide audience with minimal fuss. The present invention will work to match users to a posted need or offer posted by a first user. In addition, users may opt to receive updates (e.g. a “newsletter”) about relevant needs or offers posted by other users. The present invention will also provide the user with access to material, data, and similar resources such as recommended pages, in-content referral, free bonus links, and free coupons. Overall, once a user registers, the present invention is designed to help connect the user to opportunities in their country of origin, their country of residence, and any other countries that shows interest in the user and/or that the user is interested in. The present invention works to provide as much help as possible to benefit users and their nations generously.

More specifically, the present invention executes a matching process between a user and a plurality of searchable entities. The searchable entities for the present invention include the user profile of each user, the plurality of networking groups, and the plurality of need/offer posts. The process begins by automatically comparing the user profile of the user to each of the plurality of searchable entities in order to determine a similarity rank between the user profile and each of the plurality of searchable entities. In the preferred embodiment of the present invention, the similarity rank is given as a percentage. The process continues by designating a set of searchable entities with the highest similarity ranks. The present invention will then display this set of searchable entities with the highest similarity ranks to the user through the graphic user interface. Finally, the present invention will prompt the user to select and interact with any of the searchable entities with the highest similarity ranks. The user will interact with that searchable entity depending what kind of searchable entity it is. For example, if the high ranking searchable entities is a contact, then the user can add that contact to their contacts list. If the high ranking searchable entity is networking group, then the user can send a join-request to that networking group. If the high ranking searchable entities is a need/offer post, then the user can accept or respond to that need/offer post.

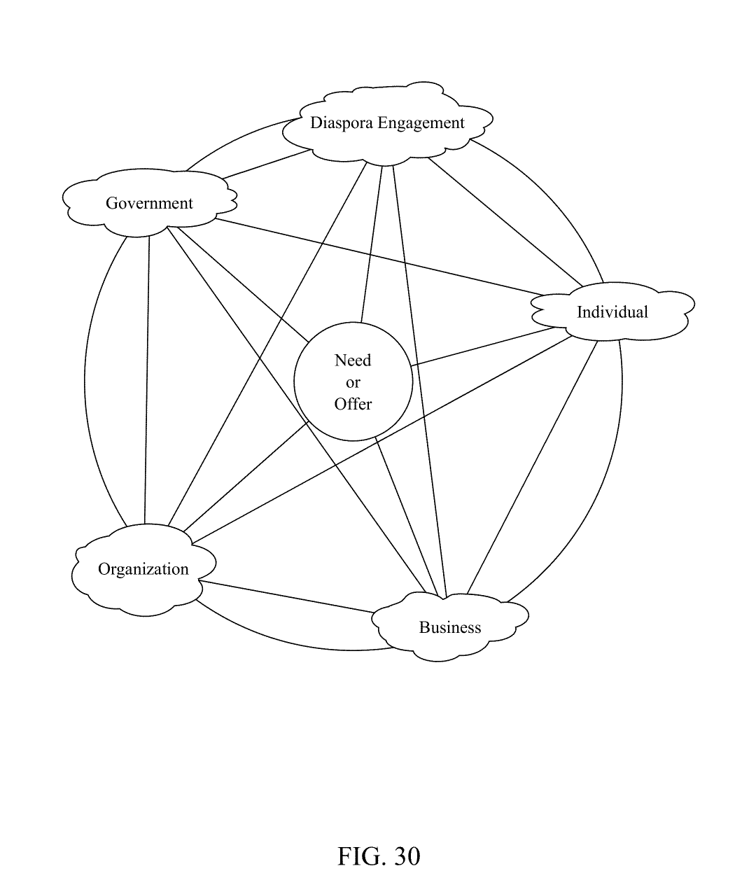

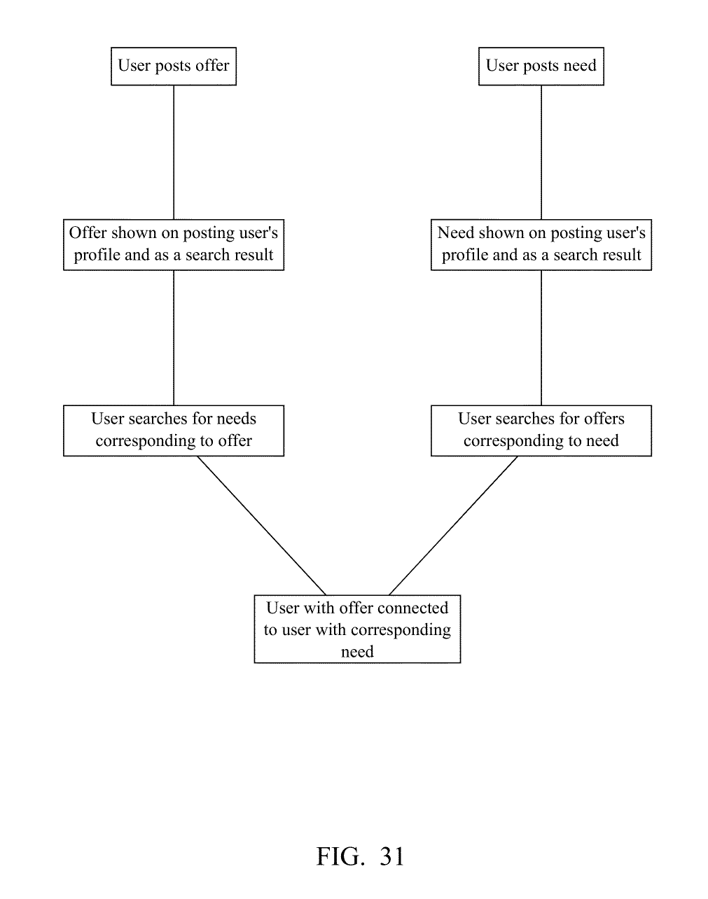

By providing a centralized service for posting needs and offers, the present invention is able to offer a number of solutions to users, whether individuals, businesses, or other groups. The present invention allows different users to connect directly and indirectly to address their respective needs and offers, as outlined in FIG. 30 and FIG. 31. For example, the present invention could help an organization find volunteers, help a business search for solutions, or help a business find new clients and opportunities. These are just a few examples of ways the present invention can benefit users. A list of additional ways the present invention can help users, not meant to be limiting, comprises:
Searching for market groups
Sales, purchases, advertizing, and promotions related to an association or network
Searching for candidates or collaborators for a project or business
Looking for a diaspora network, community, group, or association
Offering assistance to a diaspora member looking to return to their home country
Finding and recruiting qualified professionals
Starting or finding and joining a forum discussion
Obtaining assistance in solving a problem
Obtaining assistance in finding grants, fellowships, scholarships, and internships
Building professional networks to help solve problems, e.g. building a client base or increasing profit
Finding tools, companies, events, marketing, solutions, or projects for networking
Finding benchmarking opportunities
Learning strategies for finding, learning about, and interacting with people, organizations, and opportunities from other cultures
Finding solutions to consulting problems
Finding collaboration opportunities with people or organizations, regardless of country
Finding people, organizations, or opportunities to help with advocacy for development
Learning more about brain drain, brain grain, and transforming the former into the latter
Learning about challenges that the international diasporas face to better understand and work with them
Exploring strategies for successful cooperation with people and organizations in order to solve diplomatic and foreign policy issues
Finding editing services or opportunities, regardless of country
Offering educational assistance to individuals, organizations, and nations
Working to advocate human rights in a country
Finding advice, tools, and opportunities related to worldwide philanthropic activities
Connecting with people, fundraising opportunities, and initiatives locally or abroad
Finding volunteers for an organization by freely posting available volunteer positions
Finding opportunities to work as a mentor or tutor and offer products or services to persons or organizations in need of said products and services
Finding ways to quickly overcome lobbying issues, regardless of country
Assist a person in improving survival skills or adjusting to new environments and situations
Finding and recruiting qualified professionals in an area of need
Offering assistance to a refugee or receiving assistance as a refugee
Finding opportunities in banking and insurance
Connecting with persons moving to or from a resident country in order to discover new opportunities
Finding fast and easily accessible opportunities related to capacity building
Finding solutions to career related needs
Addressing issues concerning immigration and development
Finding opportunities for infrastructure investments, regardless of country
Offering assistance to travelers and recent immigrants in adjusting to their new environment by finding opportunities and building connections
Joining scientific communities to help reach a goal or solve a problem
Finding and connecting with people with similar spiritual needs and interests
Finding resources to help address adoption related issues
Finding free resources to help solve technology related problems
Finding worldwide resources to satisfy translation needs.

As seen above, the present invention benefits businesses and nonprofits by acting as a global platform where they can find resources to help solve issues and improve profits, both in their local markets and internationally. Furthermore, access to consultants is streamlined, with the present invention providing a centralized platform through which businesses can find local and international consultants, and through which consultants can advertise their services. Governments are benefitted as they may use the present invention as a resource to find and engage with any diaspora populations locally and worldwide. Individuals, such as diaspora, immigrants, and travelers, as well as nations with abundant resources and opportunities, interact to solve issues related to moving, travelling, and general migration, whether locally or abroad. Research, both public and private, is benefitted by being able to inform the world of their work, as well as find new opportunities, potential employees, potential partners, and more. All users can benefit from free advice, tools, and opportunities for philanthropic donations, whether by businesses, organizations, institutions, or nations. Retired persons can use the present invention to find tools and resources which will help make the best of their retirement, whether local or abroad. Educational facilities, their students, and their employees, and related organizations and nations are provided with the resources to work towards solving their educations issues. Students themselves are provided with access to background information and general availability of grants, fellowships, internships, scholarships, pen pal opportunities, student exchanges, study abroad programs, research openings, job postings, mentoring help, networking opportunities, teaching opportunities, tutoring opportunities, and volunteering opportunities. Those who are unemployed are provided with tools and tips to build a network and find a job or start a business anywhere in the world. Potential volunteers are linked with volunteer opportunities, both domestic and international. Users can directly and securely give and/or receive any type of goods or services to/from anyone worldwide in a way that benefits the communities, respects the environment, and the aspirations, in addition to the needs of the donors and the receivers. Charities, philanthropic organizations, and anyone who wants to make or receive a donation are brought together; therefore, making the charitable organization more accessible, pragmatic, sustainable, and visible. These are just a few examples of persons and groups benefitted by the present invention, as ultimately any user can use the present invention to develop and network with Diaspora groups, networks, communities, businesses, non-profit organizations, government agencies, and opportunities which can benefit the user and even the whole world full of needy people such as: strangers, immigrants, travelers, orphans (fatherless or motherless), widows, widowers, homeless people, hungry people, thirsty people, unemployed people, poor people, neglected people, oppressed people, etc.

To financially support as well as enhance the functionality of the present invention, a number of additional services are provided. Advertisements are hosted by the present invention for variable durations. To connect users with products, services, or solutions that cannot be directly provided by the present invention, affiliate programs are used. These present invention refers users do these affiliate programs, such as by providing a link, when desired goods or services are not available through the present invention. The implementation of an affiliate program ensures that users remain satisfied. Similar to the affiliate program, a publisher program is implemented where external publishers may be unable to provide services or goods that can be provided by the present invention. These external sites would then be able to refer their users to the present invention, or even display some of the services and products of the present invention directly on an external website. In addition, the present invention allows third-party developers to act as partners, with the partnered developers providing new applications that fit the mission and vision of the present invention. Lastly, investment opportunities can be provided to help draw interest to and fund the present invention. These are merely a few examples of additional services that can be provided by the present invention, and are not meant to be limiting. Ultimately, any additions or modifications can be made to the present invention as long as they maintain the scope of acting as a central program for connecting users to Diaspora relevant resources.

Although the invention has been explained in relation to its preferred embodiment, it is to be understood that many other possible modifications and variations can be made without departing from the spirit and scope of the invention as hereinafter claimed.

1. A method of locating, engaging, and networking diasporas by executing computer-executable instructions stored on a non-transitory computer-readable medium, the method comprises the steps of:
providing a plurality of user accounts, wherein each of said user accounts includes a user profile and a plurality of contacts;
wherein said user profile includes a residence location and an origination location; and wherein said user profile further includes a name, an address, an email, a telephone number, education, a country of origin, a duration at origin, a country of residence, a duration at residence, a country of citizenship, a tribe or culture, areas of interest, a language, an expertise, a job title, an age, and a resume, and information a user is looking for in other users: education completed of match, fields of expertise of match, areas of interest/needs/offers of match, languages of match, country of residence of match, job title of match, years of experience of match, registration category of match, country of origin of match, and the need and offer that the user posts;
displaying a plurality of communication resources through a graphic user interface to each of said plurality of user accounts:
optimizing interconnectivity between users accounts with similar residence locations and with similar origination locations by implementing said plurality of communication resources;
enabling said plurality of user accounts to send and receive messages amongst each other as one of said plurality of communication resources;
enabling each of said plurality of user accounts to view, organize, and manage its plurality of contacts as one of said plurality of communication resources;
enabling said plurality of user accounts to add need/offer posts to a common board as one of said plurality of communication resources;
enabling said plurality of user accounts to create a plurality of networking groups amongst each other as one of said plurality of communication resources;
executing a matching process for each of said plurality of user accounts as one of said plurality of communication resources, wherein an arbitrary account from the plurality of user accounts is enabled to add a specific need/offer post to said common board;
prompting said arbitrary account to select a category type for said specific need/offer post;
extracting user information for said specific need/offer post from said user profile of said arbitrary account;
retrieving description information and location information for said specific need/offer post from said arbitrary account; and
adding said specific need/offer post with said category type, user information, said description information, and location information to said common board.

2. (canceled)

3. (canceled)

4. The method of locating, engaging, and networking diasporas by executing computer-executable instructions stored on a non-transitory computer-readable medium as claimed in claim 1, wherein said category type is selected from the group consisting of a recruiter, a salesperson, a job seeker, a buyer, a volunteer, a philanthropist/donor, and a receiver, a diaspora seeking a government, a diaspora seeking a home country, a diaspora seeking a host country, a diaspora seeking an organization, a diaspora seeking an individual, and a diaspora seeking opportunities with one of the foregoing categories.

5. The method of locating, engaging, and networking diasporas by executing computer-executable instructions stored on a non-transitory computer-readable medium as claimed in claim 1, wherein said description information is selected from the group consisting of a descriptive summary, fields of expertise of the need/offer, areas of interest of the need/offer, the length of service, an availability date of the need/offer, an expiration date of the need/offer if applicable, a compensation type, location of the need/offer, user registration category, user country of origin, user areas of interest, user country of residence, duration of user residence in host country, user language preference, user profession, field of expertise, user job title, user age, and combinations thereof.

6. The method of locating, engaging, and networking diasporas by executing computer-executable instructions stored on a non-transitory computer-readable medium as claimed in claim 5, wherein said specific need/offer post is a gift and said description information is selected from the group further consisting of a gift type, a gift cost, a gift value, a delivery route, additional gift-related information, and combinations thereof.

7. The method of locating, engaging, and networking diasporas by executing computer-executable instructions stored on a non-transitory computer-readable medium as claimed in claim 1 comprises the steps of:
wherein responses is filtered for said specific need/offer post;
retrieving qualification information for said specific need/offer post from said arbitrary account;
comparing said qualification information to said user profile of each of said user accounts in order to determine suitable accounts within said plurality of user accounts for said specific need/offer post; and
enabling access to said specific need/offer post to said suitable accounts through said common board.

8. The method of locating, engaging, and networking diasporas by executing computer-executable instructions stored on a non-transitory computer-readable medium as claimed in claim 7, wherein said qualification information is selected from the group consisting of education, a country of origin, a country of residence, a duration at residence, areas of interest, a language, an expertise, a job title, an age, and combinations thereof.

9. The method of locating, engaging, and networking diasporas by executing computer-executable instructions stored on a non-transitory computer-readable medium as claimed in claim 1 comprises the steps of:
wherein an arbitrary account from the plurality of user accounts is enabled to search for a specific need/off post on said common board;
providing a category type, user information, description information, and location information for each of said need/offer posts on said common board;
retrieving search criteria for said specific need/offer post from said arbitrary account;
comparing said search criteria to said category type, said description information, and said location information for each of said plurality of need/offer posts in order to determine matching posts on said common board;
displaying each of said matching posts through said graphic user interface to said arbitrary account;
prompting said arbitrary account to select said specific need/offer post from said matching posts,
wherein, the filtering matches a need/offer posted by a user to other users based on the preferences they specified in their profile during the registration and/or after they update they profile and settings, an arbitrary account from the plurality of user accounts is enabled to search for a need/offer from the plurality of need/offer on the board, retrieving search criteria for said need/offer; comparing said search criteria to said need/offer of said plurality of need/offer in order to determine matching accounts from said plurality of needs/offers; and prompting said arbitrary account to select said need/offer result from said matching needs/offers; and
prompting said arbitrary account to respond to the need/offer to receive helps from other users and/or to help someone else in need.

10. The method of locating, engaging, and networking diasporas by executing computer-executable instructions stored on a non-transitory computer-readable medium as claimed in claim 1 comprises the steps of:
wherein an arbitrary account from the plurality of user accounts is enabled to create a specific networking group amongst said plurality of user accounts;
prompting said arbitrary account to select a category type, a country of origin, a country of residence, a continent of origin, a continent of residence for said specific networking group;
retrieving description information for said specific networking group;
prompting said arbitrary account to select other accounts from said plurality of user accounts to join said specific networking group;
sending join-requests for said specific networking group to said other accounts; and
adding said other accounts to said specific networking group with said arbitrary account,
if said other accounts accept said join-requests.

11. The method of locating, engaging, and networking diasporas by executing computer-executable instructions stored on a non-transitory computer-readable medium as claimed in claim 10, wherein said category type for is selected from the group consisting an individual, a business, a governmental institution, a research institution, a laboratory, a non-profit organization, a professional association/network, a school, a diaspora association, and an international institution.

12. The method of locating, engaging, and networking diasporas by executing computer-executable instructions stored on a non-transitory computer-readable medium as claimed in claim 1 comprises the steps of:
wherein an arbitrary account from the plurality of user accounts is enabled to join a specific networking group;
retrieving search criteria for said specific networking group from said arbitrary account;
comparing said search criteria against each of said plurality of groups in order to determine matching groups from said plurality of groups;
prompting said arbitrary account to select said specific networking group from said matching groups;
sending a join-request from said arbitrary account to said specific networking group; and
adding said arbitrary account to said specific networking group,
if said specific networking group accepts said join-request.

13. The method of locating, engaging, and networking diasporas by executing computer-executable instructions stored on a non-transitory computer-readable medium as claimed in claim 1 comprises the steps of:
wherein an arbitrary account from the plurality of user accounts is enabled to view, organize, and manage its plurality of contacts;
displaying its plurality of contacts to said arbitrary account through said graphic user interface;
prompting said arbitrary account to select a piece of sorting information from said user profile;
organizing its plurality of contacts by said piece of sorting information, when said arbitrary account selects said piece of sorting information;
prompting said arbitrary account to select a specific contact from its plurality of contacts; and
displaying said user profile of a user account corresponding to said specific contact, when said arbitrary account selects said specific contact.

14. The method of locating, engaging, and networking diasporas by executing computer-executable instructions stored on a non-transitory computer-readable medium as claimed in claim 1, comprises the steps of:
wherein an arbitrary account from the plurality of user accounts is enabled to add new contacts to its plurality of contacts;
retrieving search criteria for said new contacts from said arbitrary account;
comparing said search criteria to said user profile of each of said plurality of user accounts in order to determine matching accounts from said plurality of user accounts;
prompting said arbitrary account to select said new contacts from said matching accounts;
sending join-requests to said new contacts from said arbitrary account; and
adding said new contacts to said plurality of contacts of said arbitrary account,
if said new contacts accept said join-requests.

15. The method of locating, engaging, and networking diasporas by executing computer-executable instructions stored on a non-transitory computer-readable medium as claimed in claim 14, wherein said search criteria for is selected from the group consisting a country of origin, a country of residence, a first name, a last name, an education, a country of origin, a city of origin, a duration at origin, a country of residence, a city of residence, a duration at residence, a country of citizenship, a tribe or culture, an areas of interest, a language, an expertise, a job title, an age; and information about the things that the user is looking for in other users: education completed of match, fields of expertise of match, areas of interest/needs/offers of match, languages of match, country of residence of match, job title of match, years of experience of match, registration category of match, country of origin of match, and combinations thereof.

16. The method of locating, engaging, and networking diasporas by executing computer-executable instructions stored on a non-transitory computer-readable medium as claimed in claim 1 comprises the steps of:
wherein an arbitrary account from the plurality of user accounts is enabled to send a message;
prompting said arbitrary account to select a specific contact from its plurality of contacts;
prompting from said arbitrary account to compose said message through said graphic user interface;
retrieving subject and content of said message through said graphic user interface;
extracting user information from said user profile of said arbitrary account;
adding said user information to said message; and
sending said message to said specific contact, wherein said specific contact corresponds to a specific account from said plurality of user accounts.

17. The method of locating, engaging, and networking diasporas by executing computer-executable instructions stored on a non-transitory computer-readable medium as claimed in claim 1 comprises the steps of:
wherein an arbitrary account from the plurality of user accounts is enabled to receive a new message;
receiving said new message from another user account,
if said plurality of contacts for said arbitrary account contains said other user account;
prompting the user to select a specific contact from their contacts list;
prompting the user to compose the message through the graphic user interface and consequently retrieving the subject and the content of the message through a graphic user interface as the user types into the designated areas of the graphic user interface;
extracting user information from the user profile of the user creating message;
adding the user information to the message and sending the message to the specific contact;
enabling a user to receive a new message from another user if the sender is on a contact list of the recipient user;
notifying the recipient user of the new message from the other user;
displaying a subject and a content of the new message, and displaying the user information for the other user to the recipient user;
notifying said arbitrary user account of said new message from said other user account;
displaying subject and content of said new message to said arbitrary user account through said graphic user interface; and
displaying user information of said other user account through said graphic user interface.

18. The method of locating, engaging, and networking diasporas by executing computer-executable instructions stored on a non-transitory computer-readable medium as claimed in claim 1 comprises the steps of:
wherein said matching process is executed for an arbitrary account from the plurality of user accounts;
wherein said user profile of each of said plurality of user accounts, said plurality of networking groups, and said plurality of need/offer posts are together considered as a plurality of searchable entities;
automatically comparing said user profile of said arbitrary account to each of said plurality of searchable entities in order to determine a similarity rank between said user profile and each of said plurality of searchable entities;
designating a set of searchable entities with highest similarity ranks from the plurality of searchable entities;
displaying said set of searchable entities with said highest similarity ranks to said arbitrary account; and
prompting said arbitrary account to select from and interact with said set of searchable entities with said highest similarity ranks.
